(19) United States
(12) Patent Application Publication
(10) Pub. No.: US 2018/0247012 A1
(43) Pub. Date: Aug. 30, 2018

(54) BIOINFORMATICS DATA PROCESSING SYSTEMS

(71) Applicant: AGENCY FOR SCIENCE, TECHNOLOGY AND RESEARCH, Singapore (SG)

(72) Inventors: Davide VERZOTTO, Singapore (SG); Niranjan NAGARAJAN, Singapore (SG)

(21) Appl. No.: 15/558,503

(22) PCT Filed: Mar. 16, 2016
(86) PCT No.: PCT/SG2016/050121

§ 371 Date: Sep. 14, 2017

(30) Foreign Application Priority Data
Mar. 17, 2015 (SG) 10201502027V

(51) Int. Cl. G06F 19/22

(52) U.S. Cl. CPC G06F 19/22

(57) ABSTRACT

Disclosed is a computer-implemented method of determining at least one optimal alignment of at least part of a first map to at least part of a second map or a plurality of second maps, wherein the maps are physical genome maps and/or restriction maps. The method comprises: receiving first map data indicative of a first ordered list of distances between features of the first map, receiving second map data indicative of a second ordered list of distances between features of the second map or second maps; generating, from the second map data, seed data indicative of a plurality of seeds, each seed comprising at least one of the distances in the second ordered list, wherein the features are restriction sites and distances are fragment sizes. The said method further comprises generating a plurality of candidate alignments from the seed data by searching at least part of the first ordered list to find at least approximate matches for respective seeds, and extending the approximate matches by dynamic programming; determining respective alignment scores for respective candidate alignments; and selecting one or more of the candidate alignments as an optimal alignment or optimal alignments, based on the alignment scores.

### FIELD OF THE INVENTION

This invention generally relates to methods and systems for map alignment, in particular map-to-sequence alignment, more particularly for determining at least one optimal alignment of at least part of a first map, for example a first physical genome map, to at least part of a second map or plurality of second maps, for example second physical genome maps.

### BACKGROUND TO THE INVENTION

Resolution of complex repeat structures and rearrangements in the assembly and analysis of large eukaryotic genomes is often aided by a combination of high-throughput sequencing and genome-mapping technologies (for example, optical restriction mapping). In particular, mapping technologies can generate sparse maps of large DNA fragments (150 kilo base pairs (kbp) to 2 Mbp) and thus provide a unique source of information for disambiguating complex rearrangements in cancer genomes.

Despite their utility, combining high-throughput sequencing and mapping technologies has been challenging because of the lack of efficient and sensitive map-alignment algorithms for robustly aligning error-prone maps to sequences.

Recently, the availability of commercial platforms for high-throughput genome mapping (from, for example, OpGen, BioNano Genomics, and Nabsys) has increased the interest in using these technologies, in combination with high-throughput sequencing data, for applications such as structural variation analysis and genome assembly. In particular, several recent genome assembly projects have highlighted their utility for obtaining high-quality assemblies of large eukaryotic genomes (for example, goat (Dong, Y. et al., Nature Biotechnology. 2013; 31, 135-141) and budgerigar genomes (Ganapathy, G. et al., GigaScience. 2014; 3(1), 11)) or studying complex genomic regions (Lam E T. et al., Nature Biotechnology. 2012; 30:771-776) and cancer genomes (Ray M. et al., BMC Genomics. 2013; 14:505). Mapping technologies typically provide sparse information (an ordered enumeration of fragment sizes between consecutive genomic patterns, for example, restriction sites) for very large fragments of DNA (150 kilo base pairs (kbp) to 2 Mbp) and are thus orthogonal in utility to sequencing approaches that provide a base-pair level information for smaller fragments. Combining these two pieces of information therefore requires effective algorithms to align maps to sequences.

Alignment of maps (typically called Rmaps, for restriction maps (Waterman M S. et al., Nucleic Acids Research. 1984; 12:237-242)) to sequences has been widely studied as an algorithmic problem (Mendelowitz L. et al., GigaScience. 2014; 3:33) with a range of practical applications, from genome scaffolding (Nagarajan N. et al., Bioinformatics. 2008; 24:1229-1235) to assembly improvement (Lin H. et al., BMC Bioinformatics. 2012; 13:189) and validation (Antoniotti M. et al., Genomics via Optical Mapping IV: Sequence Validation via Optical Map Matching. New York, BY USA: New York University; 2001). The general approach has been to translate sequence data to get in silico maps and compare these to experimentally obtained maps using dynamic programming algorithms. For large genomes and mapping datasets, naive all-versus-all dynamic programming can be computationally expensive. On the other hand, high error rates in mapping data (optical mapping, for example, can miss one in four restriction sites) has led to the use of model-based scoring functions for sensitively evaluating alignments (Valouev A. et al, Journal of Computational Biology. 2006; 13:442-462; Anantharaman T S. et al., Analysis of False Positives in Optical Map Alignment and Validation. In: First International Workshop on Algorithms in Bioinformatics (WABI 2001). Aarhus, Denmark: Springer; 2001. p. 27-40; Sarkar D. et al., Journal of Computational Biology. 2012; 19:478-492). These often require prior knowledge and modeling of mapping error rates (for example, fragment sizing errors, false cuts and missing cuts) and can be expensive to compute (Anantharaman T S. et al., Journal of Computational Biology. 1997; 4:91-118; Anantharaman T S. et al., Genomics via Optical Mapping III: Contiging Genomic DNA. In; Proceedings of the 7^{th} International Conference on Intelligent Systems for Molecular Biology (ISMB 1999). Heidelberg, Germany: AAAI; 1999 p. 18-27). Alternative approaches with simpler (non-model-based) scoring functions (Nagarajan N. et al., Bioinformatics. 2008; 24:1229-1235) are handicapped by the need to do expensive permutation-based statistical testing to evaluate the significance of alignments, and although recent advances have made this testing more efficient (Sarkar D. et al., Journal of Computational Biology. 2012; 19:478-492), it still scales linearly with genome size. Although these approaches work well for microbial genomes, they typically do not scale well for larger genomes, where they might also have reduced sensitivity. In contrast, commercially available solutions for map-to-sequence alignment (for example, Genome-Builder from OpGen) scale better and have been used for the assembly of large eukaryotic genomes (Dong Y. et al, Nature Biotechnology. 2013; 31:135-141) but tend to discard a large fraction of the mapping data (more than 90%) due to reduced sensitivity and correspondingly lead to increased mapping costs for a project.

Map-alignment algorithms are thus faced with the twin challenges of improving sensitivity and precision on the one hand and reducing computational costs for alignment and statistical evaluation on the other hand. An elegant solution to this problem from the field of sequence-to-sequence alignment is the use of a seed-and-extend approach (Karp R M. et al., IBM J Res Dev. 1987; 31:249-260). However, because maps represent ordered lists of continuous values, this extension is not straightforward, particularly when multiple sources of mapping errors and their high error rates are taken into account (Muggli M D. et al, Efficient Indexed Alignment of Contigs to Optical Maps. In; Algorithms in Bioinformatics (WABI 2014). Vol. 8701 of LNCS. Wroclaw, Poland: Springer; 2014 p. 68-81). In addition, because error rates can vary across technologies, and even across different runs on the same machine, it is not clear whether a general sensitive map-to-sequence aligner is feasible. An efficient statistical testing framework that helps control for false discovery without prior information about error rates is critical for making such an aligner easy to use and applicable across technology platforms.

There is a need for efficiently and sensitively detecting seed map-to-sequence alignments and for designing a robust and fast statistical evaluation approach.

### SUMMARY OF THE INVENTION

According to a first aspect of the present invention, there is therefore provided a computer-implemented method of determining at least one optimal alignment of at least part of a first map to at least part of a second map or a plurality of second maps, the method comprising: receiving first map data indicative of a first ordered list of distances between features of the first map; receiving second map data indicative of a second ordered list of distances between features of the second map or second maps; generating, from the second map data, seed data indicative of a plurality of seeds, each seed comprising at least one of the distances in the second ordered list; generating a plurality of candidate alignments from the seed data by searching at least part of the first ordered list to find at least approximate matches for respective seeds, and extending the approximate matches by dynamic programming; determining respective alignment scores for respective candidate alignments; and selecting one or more of the candidate alignments as an optimal alignment or optimal alignments, based on the alignment scores.

The skilled person will appreciate that there are many ways in which an alignment score may be obtained. Generally, the alignment score may be defined based on a minimum of a function that is dependent from a difference between distances of features of the first and second maps, respectively. The minimum may provide for the optimal alignment. Alignment scores are for example based on p-values. In some embodiments, the alignment score is based on a normalised difference between summed distances in the first and second maps, respectively. The alignment score is, in some embodiments, based on the total number of cut errors (which include missing cuts, false cuts and missing fragments). In some embodiments, any combination of the above examples may be used to define alignment scores.

In embodiments, the scoring function may be used to select locally optimal alignments. The final alignment reported may be the one, for example, with the most significant Z-score.

As part of the (at least one) optimal alignment determination, dynamic programming is used, whereby the problem of aligning larger portions is broken down into a collection of sub-problems. The solution of each of those sub-problems may be stored and re-used for subsequent computations, thereby saving computational time.

Embodiments of the method of determining at least one optical alignment of at least part of a first map to at least part of a second map or maps described herein address the need for a wide range of applications, for example from genome assembly to structural variation analysis. Embodiments of the method described herein improve sensitivity and runtime while providing highly precise alignments in a range of experimental settings.

Embodiments of the method may be applicable to read and map datasets from, for example, human cell lines, and may significantly reduce the cost of, for example, optical mapping analysis and thus increase its usage.

The skilled person will appreciate that embodiments of the method described herein may be used to find an optimal alignment between any type of data sets. Embodiments of the method may be particularly useful for aligning sequences of, for example, a human genome and in silico maps, as will be further described below. Embodiments described herein may also be applied to, for example, a map-to-map alignment problem or a sequence-to-map alignment problem.

Embodiments of the method described herein may introduce composite seeds, which may echo the idea of spaced seeds in the context of continuous-valued sequence alignment. Composite seeds may allow developing efficient seed-and-extend aligners for map-to-sequence alignment of erroneous mapping data. Embodiments of the method may similarly be applied for map-to-map alignment, de novo assembly of experimental maps, and sequence-to-map alignment.

Embodiments of the method described herein may allow developing a conservative statistical testing approach which may not require knowledge of the true distribution of errors or an expensive permutation test to evaluate the uniqueness and significance of alignments. This may allow to significantly reduce the runtime cost of this step without sacrificing specificity or the ability to be agnostic with respect to error rates.

Embodiments described herein may therefore allow for efficiently and sensitively detecting seed map-to-sequence alignments based on a sorted search index and the use of a composite seeding strategy. Furthermore, embodiments may allow for a robust and fast statistical evaluation approach to be designed, which may include multiple sources of mapping errors in the alignment score and evaluates the significance of the best alignment using all identified feasible solutions.

Embodiments described herein may therefore allow for solving two common alignment problems: glocal (short for global-local) alignment, solved with what is dubbed OPTIMA, where an entire map may be aligned to a subsequence of a second (for example in silico) map; an overlap alignment, solved with what is dubbed OPTIMA-Overlap, where the end of one map may be aligned to the beginning or end of another.

Compared to state-of-the-art aligners, OPTIMA and OPTIMA-Overlap may provide for an increase in sensitivity (around 1.6-2 times) without sacrificing precision of alignments (˜99%).

Embodiments described herein may exhibit runtime improvements over commercially available tools (for example two times faster than OpGen's Gentig) and orders of magnitude over state-of-the-art algorithms and software.

Embodiments of the method described herein may be robust to variations in error distributions while being agnostic to them. Embodiments of the method may therefore deal with different experimental outcomes of the same technology (for example, different map cards or lane types) as well as being applicable across mapping technologies (with, potentially, minor modifications for pre-processing of data).

Because glocal and overlap alignments may form the basis of a range of applications that involve the combination of sequence and mapping data (for example, assembly scaffolding, refinement and validation, structural variation analysis and resolving complex genomic regions), OPTIMA and OPTIMA-Overlap may serve as building blocks for these applications, allowing for time- and cost-effective analyses.

In a preferred embodiment of the method, the first map is a physical genome map. As outlined above, resolution of complex repeat structures and rearrangements in the assembly and analysis of, for example, large eukaryotic genomes is often aided by a combination of high-throughput sequencing and genome-mapping technologies (for example, optical restriction mapping). In particular, mapping technologies can generate sparse maps of large DNA fragments and thus provide a unique source of information for disambiguating complex rearrangements in, for example, cancer genomes. Embodiments of the methods described herein, which allow for efficient and sensitive map-alignment are therefore particularly suitable for physical genome maps.

In a further preferred embodiment of the method, the, or each, second map is a physical genome map. As outlined above, efficient alignment and improved runtime may make embodiments of the method described herein particularly suitable for physical genome maps, in particular since physical maps may contain errors, for example empirical errors.

In a preferred embodiment of the method, the first map and/or the second map is a restriction map, the features are restriction sites, and the distances are fragment sizes. Preferably, the restriction map (or nicking enzyme-based map or nanopore-based map) is an optical map (or a genome map or a positional map).

In a further preferred embodiment of the method, the second map or maps is or are generated from one or more nucleotide sequences.

Preferably, the second map or maps is or are generated by searching for one or more patterns in the one or more nucleotide sequences, and determining distances between successive matches from said searching. This may allow using a score to evaluate whether the candidate alignment may be optimal, statistically significant and/or unique.

An optimal alignment is hereby defined as being statistically significant when a measure of similarity of the aligned maps is above a (pre-determined) threshold. The measure of similarity may be, but is not limited to, a measure based on counts, for example counts of matching fragments of the aligned maps. It will be appreciated that other types of measures may be used to determine a degree of similarity between the maps, for example, a weighted count in which a larger size of fractions/portions matching between the maps is weighted more than relatively smaller fractional sizes of matched, aligned fractions/portions, and/or a relative number of counts of matched, aligned features of the maps with respect to the total number of features in the map(s).

In a further preferred embodiment, each pattern is a restriction enzyme recognition sequence. For example, high-throughput genome mapping technologies may use enzymes such as restriction enzymes to recognize and label specific patterns throughout the genome. These patterns may then be read out to obtain an ordered set of fragment sizes for each DNA molecule. Embodiments therefore allow for converting available corresponding genome sequences or assemblies into in silico maps through pattern recognition.

Alternatively, each pattern is a nicking enzyme or nanopore-based enzyme.

In a further preferred embodiment of the method, the seeds are composite seeds each comprising a plurality of c-tuples, each c-tuple comprising one or more successive distances and/or one or more sums of successive distances in the second ordered list. As will be further described below, this may allow for significantly reducing the space of candidate alignments without affecting the sensitivity of the search. The number of alignments computed using embodiments of the method may therefore be drastically reduced in comparison to more general, global alignment searches, as will be shown below.

In a preferred embodiment, c is greater than or equal to 2 for at least some of the c-tuples, which relates to the use of a (more) stringent threshold for seed matching.

In a further preferred embodiment of the method, the dynamic programming and/or the searching of the first ordered list comprises finding a feasible match between a subset of distances of the second ordered list and a subset of distances of the first ordered list.

A match is defined as being feasible when modulus of the difference between (for example summed) distances of the first ordered list and the second ordered list, respectively, is below a (pre-determined) threshold. It will be appreciated by the skilled person that there are many ways in which the difference between distances of the first ordered list and second ordered list, respectively, may be determined. For example, the total (summed) distances of each list may be used as a measure for determining the difference or a weighted sum of distances may be used to determine the difference.

Extending the definition of correspondence between map fragments to allow for matches between sets of fragments may be preferable to accommodate errors. It will be appreciated that, in practice, many sources of errors may affect experimentally-derived maps, including, but not limited to, missing cuts, false/extra cuts, missing fragments, fragment sizing errors and spurious maps. In silico maps may also be affected by sequencing or assembly errors. It may therefore be preferable to find a feasible match between a subset of distances of the second ordered list and a subset of distances of the first ordered list.

In a preferred embodiment, a feasible match is found if the following is satisfied:

$$\vert \frac{{\sum }_{i = k}^{s} {o}_{i} - {\sum }_{j = l}^{t} {r}_{j}}{\sqrt{{\sum }_{i = k}^{s} {σ}_{i}^{2}}} \vert \leq {C}_{σ} ,$$

where rⱼ is the subset of distances of the second ordered list, oᵢ is the subset of distances of the first ordered list, k and s are beginning and end indices of the match in the first ordered list, l and t are beginning and end indices of the match in the second ordered list, σᵢ are respective standard deviations of the distances in the subset of the first ordered list, and C_{σ} is a match stringency threshold.

In a further preferred embodiment, a feasible match is found if the following is satisfied:

$$\vert \frac{{\sum }_{i = k}^{s} {o}_{i} - {\sum }_{j = l}^{t} {r}_{j}}{\sqrt{{\sum }_{j = l}^{t} {σ}_{j}^{2}}} \vert \leq {C}_{σ}$$

where rⱼ is the subset of distances of the second ordered list, oᵢ is the subset of distances of the first ordered list, k and s are beginning and end indices of the match in the first ordered list, l and t are beginning and end indices of the match in the second ordered list, σⱼ are respective standard deviations of the distances in the subset of the second ordered list, and C_{σ} is a match stringency threshold.

In a preferred embodiment, C_{σ} is different for the dynamic programming and the searching of the first ordered list. Preferably, C_{σ} is 2 for the searching of the first ordered list and C_{σ} is 3 for the dynamic programming. C_{σ}=3 may be an appropriate bound if sizing errors are approximately normally distributed.

In a further preferred embodiment of the method, the respective alignment scores comprise Z-scores. This may be preferable as each Z-score may take into account the mean and standard deviation of a particular feature f among all candidate alignments found.

In a preferred embodiment, the alignment score for a candidate alignment π is determined according to

$$ϑ ( π ∈ Π ) = Z \text{-} score ( {\sum }_{i} {s}_{i} \times Z \text{-} score ( π , {f}_{i} ) ) ,$$

where fᵢ are features in a feature space, each feature representing a characteristic of the candidate alignment, sᵢ is 1 if lower values of feature fᵢ are preferable and sᵢ is −1 otherwise, and Π is a subset of the possible candidate alignments. This may be preferable as all considered features fᵢ are accounted for.

Here, Z-score (π, f) may take into account the mean and standard deviation of a particular feature f among all candidate alignments found:

$$Z \text{-} score ( π ∈ Π , f ) = \frac{{f}_{π} - Mean ( {f}_{Π} )}{SD ( {f}_{Π} )}$$

In a further preferred embodiment, the alignment score for a candidate alignment 7 is determined according to

ϑ(π∈Π)=Z-score(−Z-score(π,#matches)+Z-score(π,#cuterrors)+Z-score(π,WHT(χ²,#matches))),

where #matches is the number of matching distances in the candidate alignment, #cuterrors is the number of cut errors identified by the alignment in the first map and/or the second map(s), and WHT(χ²,#matches) is the Wilson-Hilferty Transformation of the χ² score for sizing errors,

$$WHT ( {x}^{2} , \# matches ) = \frac{\sqrt[3]{\frac{{x}^{2}}{\# matches}} - ( 1 - \frac{1}{9} \frac{2}{\# matches} )}{\sqrt{\frac{1}{9} \frac{2}{\# matches}}} .$$

As will be appreciated, by the central theorem, the mean of the first two features may be approximated by the normal distribution when the number of candidate solutions is large enough (for example, greater than 60 distinct solutions), and, by Slutsky's theorem, their sample variance may not have a significant effect on the distribution of the test statistics. As lower values of #cuterrors and WHT(χ²,#matches) may indicate better solutions, while a higher number of matches may represent more reliable alignments, embodiments may therefore be used to adjust the signs of Z-scores accordingly.

In a preferred embodiment, the method comprises converting the alignment scores to p-values; returning one or more candidate alignments as the optimal alignment(s) if the one or more candidate alignments meet an alignment score threshold and/or a p-value threshold; otherwise, returning no candidate alignments. Preferably, the method further comprises assessing statistical significance of the optimal alignment(s).

In a preferred embodiment, the statistical significance is assessed by determining a false discovery rate (FDR) q-value for the optimal alignment and each other candidate alignment. This may allow for obtaining an (approximately) comparable alignment of different first maps, which may, for example, have the same number of fragments, over the same set of second maps.

Embodiments may therefore advantageously allow for finding an optimal solution and to evaluate its statistical significance and uniqueness in a unified framework, thus allowing for savings in computational time and space compared to a permutation test, without restricting the method to a scenario where experimental error probabilities are known a priori.

In a further preferred embodiment, the method comprises: generating a plurality of sub-maps from the first map, the sub-maps being overlapping windows of the first ordered list; for each sub-map, determining one or more optimal alignments of the sub-map to the one or more second maps; and if an optimal alignment for a sub-map is statistically significant, extending said statistically significant optimal alignment by dynamic programming. This may allow for ranking optimal solutions to sub-problems and iterating through to select sub-maps that may or should be extended. At each stage, the significance and uniqueness of the reported solutions (compared to others) may be checked. Furthermore, potential cases of identical or conflicting alignments may be identified, as will be further described below. This may advantageously improve the sensitivity for finding one or more optimal alignments.

In a related aspect of the invention, there is provided a non-transitory computer readable medium having program instructions stored thereon for causing at least one processor to carry out the method according to embodiments described herein.

In a further related aspect of the present invention, there is provided a system for determining at least one optimal alignment of at least part of a first map to at least part of a second map or a plurality of second maps, the system comprising an alignment component which is configured to: receive first map data indicative of a first ordered list of distances between features of the first map; receive second map data indicative of a second ordered list of distances between features of the second map or second maps; generate, from the second map data, seed data indicative of a plurality of seeds, each seed comprising at least one of the distances in the second ordered list; generate a plurality of candidate alignments from the seed data by searching at least part of the first ordered list to find at least approximate matches for respective seeds, and extending the approximate matches by dynamic programming; determine respective alignment scores for respective candidate alignments; and select one or more of the candidate alignments as an optimal alignment or optimal alignments, based on the alignment scores.

It will be understood that preferred embodiments as outlined above with regard to the computer-implemented method may be performed using the above system.

In a further related aspect of the present invention, there is provided a system for determining at least one optimal alignment of at least part of a first map to at least part of a second map or a plurality of second maps, the system comprising at least one processor communicatively coupled to a memory, the memory having stored thereon computer-readable instructions for causing the at least one processor to carry out a method according to embodiments described herein.

### BRIEF DESCRIPTION OF THE DRAWINGS

These and other aspects of the invention will now be further described, by way of example only, with reference to the accompanying figures, wherein like numerals refer to like parts throughout, and in which:

FIGS. 1a-e show an example of a genomic map and strategies for glocal and overlap map alignment according to embodiments of the present invention;

FIG. 2 shows a flowchart of an alignment method according to embodiments of the present invention;

FIGS. 3a and b show a comparison of sensitivity between different seeding approaches for the human genome according to embodiments of the present invention;

FIG. 4 shows a representation of candidate alignments as a function of alignment features according to embodiments of the present invention;

FIG. 5 shows a flowchart of an alignment method according to embodiments of the present invention;

FIGS. 6a-h show glocal alignment as a function of the number of fragments in the experimental maps according to embodiments of the present invention;

FIG. 7 shows trade-off for partial overlap detection according to embodiments of the present invention;

FIG. 8 shows a flowchart of an alignment method according to embodiments of the present invention;

FIG. 9 shows a schematic block-diagram of a system according to embodiments of the present invention;

FIG. 10a-c show normal Q-Q plots of the pre-processed sizing error model applied to optical mapping data, and corresponding violin plots according to embodiments of the present invention; and

FIG. 11 shows a representative optical map of GM12878.

### DETAILED DESCRIPTION OF PREFERRED EMBODIMENTS

We describe a novel seed-and-extend glocal (short for global-local) alignment method, OPTIMA (and a sliding-window extension for overlap alignment, OPTIMA-Overlap), which allows for creating indexes for continuous-valued mapping data while accounting for mapping errors. We also present a novel statistical model, agnostic with respect to technology-dependent error rates, for conservatively evaluating the significance of alignments without relying on expensive permutation-based tests.

As will be shown, OPTIMA and OPTIMA-Overlap are advantageous over state-of-the-art approaches as they are more sensitive (1.6-2 times more sensitive), more efficient (170-200%) and more precise in their alignments (nearly 99% precision). These advantages are independent of the quality of the data, suggesting that our indexing approach and statistical evaluation are robust, provide improved sensitivity and guarantee high precision.

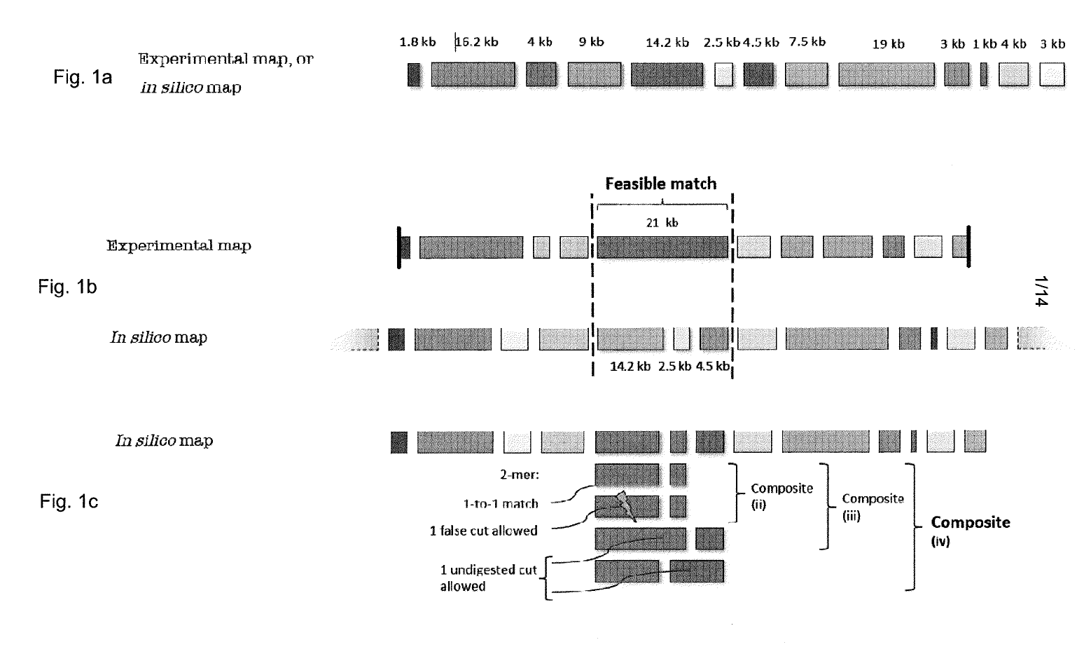

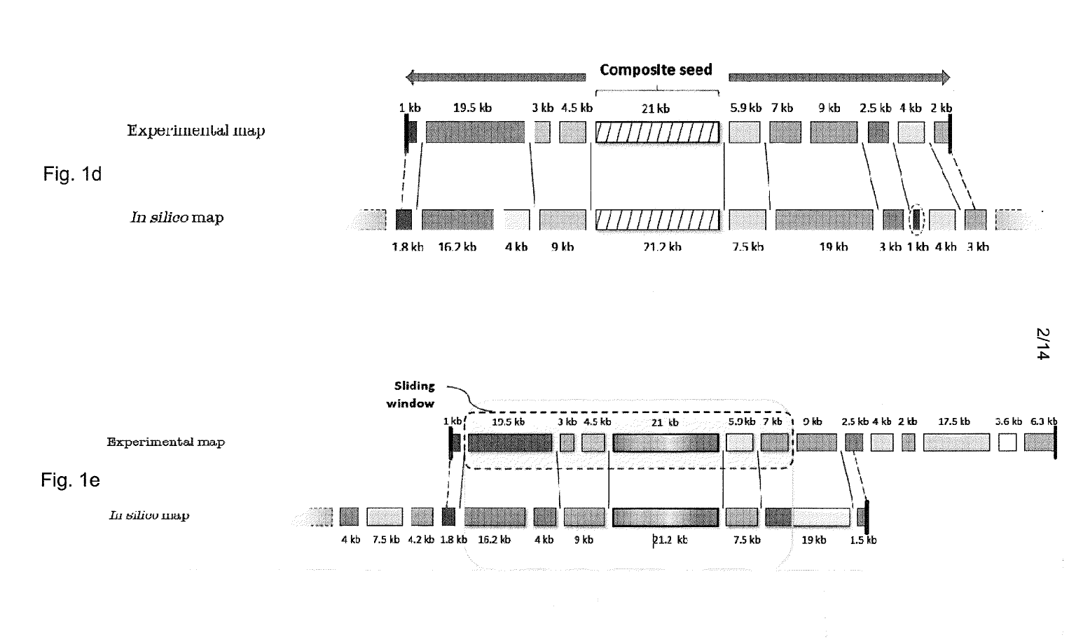

High-throughput genome mapping technologies typically work by linearizing large molecules of DNA (for example, in nanochannel or nanocoding arrays—Lam E T et al., Nature Biotechnology. 2012; 30:771-776) and using enzymes such as restriction enzymes to recognize and label (for example, by cutting DNA) specific patterns throughout the genome (for example, a 6-mer motif). These patterns are then read out (typically, optically) to obtain an ordered set of fragment sizes for each DNA molecule—see FIG. 1a for an example of a map. FIG. 1a shows an example of an experimental or in silico map with ordered fragment sizes. If corresponding genome sequences or assemblies are available, these can be converted into in silico maps through pattern recognition (Sarkar D. et al, Journal of Computational Biology. 2012; 19:478-492).

Let o1, o2, . . . , oₘ be the m ordered fragment sizes of an experimentally derived map o and r1, r2, . . . , rₙ be the n fragment sizes of an in silico map r. For simplicity, we suppose here that m≤n and assume that we can derive standard deviations for in silico fragments, that is, σⱼ for rⱼ, in a technology-dependent fashion. In an idealized case, we can define the problem of glocally aligning o to r as a one-to-one correspondence between all the fragments of o with a subset of the fragments of r, that is, rₗ, rₗ₊₁, . . . , rₗ₊ₘ₋₁ (we could also reverse the roles of o and r here). In practice, many sources of errors may affect experimentally derived maps, including missing cuts, false/extra cuts, missing fragments, fragment sizing errors and spurious maps. In silico maps could also be affected by sequencing or assembly errors, but these are less likely to affect alignments because typically they are infrequent. To accommodate errors, we extend the definition of correspondence between map fragments to allow for matches between sets of fragments (see FIG. 1b, which shows a feasible match within dashed bars (Definition 1 below)).

### Definition 1 (Feasible Match)

A subset of fragments oₖ, oₖ₊₁; . . . ; oₛ aligned as a whole entity to a subset of in silico fragments rₗ, rₗ₊₁, . . . , rₜ is called a feasible match if and only if:

$$\vert \frac{{\sum }_{i = k}^{s} {o}_{i} - {\sum }_{j = l}^{t} {r}_{j}}{\sqrt{{\sum }_{j = l}^{i} {σ}_{j}^{2}}} \vert \leq {C}_{σ} , \qquad ( 1 )$$

where C_{σ}=3 is an appropriate bound if sizing errors are approximately normally distributed.

### Definition 2 (Glocal Alignment)

A valid glocal alignment is an ordered set of matches M₁, M₂, . . . , M_{w} between experimental and in silico fragments, such that all the experimental fragments o1, o2, . . . , oₘ are aligned to a subset of the in silico fragments rₜ, rₜ₊₁, . . . , rᵥ, and both sets are orderly partitioned by all the matches M_{1 . . . w} without overlaps, with w≤m and w≤v−t+1.

Missing fragments, which usually arise from short fragments below the experimental detection limit (for example, 2 kbp), can be handled in this framework by allowing gaps, that is, with the option of ignoring short fragments for the purpose of the C_{σ} test (Equation 1).

### Definition 3 (Overlap Alignment)

A valid overlap alignment is an ordered set of matches M₁, M₂, . . . , M_{w} that allows experimental maps and in silico maps to only partially align with each other, with M₁ and M_{w} each corresponding to an end of one of the maps (for example, FIG. 1e). In FIG. 1e, which shows a sliding-window approach in overlap alignment, for a particular window of fixed size (dashed black border), we first compute a glocal alignment (solid yellow border) from one of its seeds (multicolored box), statistically evaluate it and subsequently extend it until the end of one of the maps is reached on both sides of the seed.

In general, because maps can have truncated ends, we relax the C_{σ} test to be only an upper bound on matches comprising the ends of experimental maps, for example:

$${\sum }_{i = k}^{m} {o}_{i} - {\sum }_{j = l}^{t} {r}_{j} \leq {C}_{σ} \sqrt{{\sum }_{j = l}^{t} {σ}_{j}^{2}} ,$$

or a lower bound on matches at the ends of in silico maps, for example

$${\sum }_{i = k}^{s} {o}_{i} - {\sum }_{j = l}^{v} {r}_{j} \geq {C}_{σ} \sqrt{{\sum }_{j = l}^{v} {σ}_{j}^{2}} .$$

### Materials and Methods

OPTIMA is, to the best of the inventors' knowledge, the first alignment tool based on the seed-and-extend paradigm that can deal with erroneous mapping data. The basic paradigm is similar to that used for the alignment of discrete-valued sequences (allowing for mismatches and indels) and is as follows.

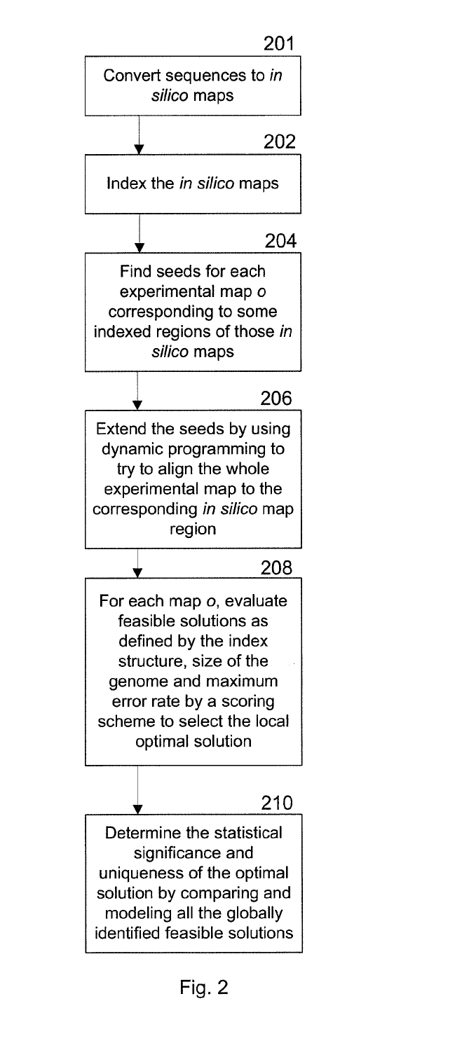

FIG. 2 shows a flowchart of an alignment method as described herein.

We start by converting sequences to in silico maps (step 201) and indexing the in silico maps (step 202), so that we can use this information later, and find seeds for each experimental map o corresponding to some indexed regions of those in silico maps (step 204). We then extend these seeds by using dynamic programming to try to align the whole experimental map to the corresponding in silico map region (step 206). For each map o, feasible solutions—as defined by the index structure, size of the genome and maximum error rate—are then evaluated by a scoring scheme to select the local optimal solution (step 208). Finally, the statistical significance and uniqueness of the optimal solution are determined by comparing and modeling all the globally identified feasible solutions (step 210).

### Indexing Continuous-Valued Seeds

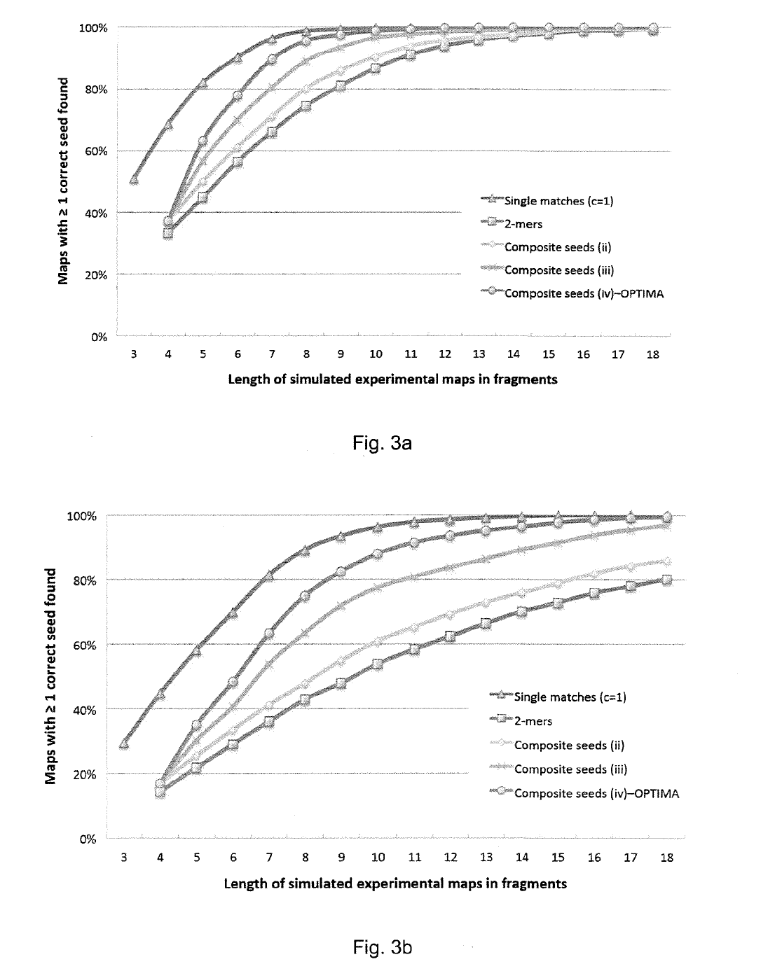

The definition of appropriate seeds is critical in a seed-and-extend approach in order to maintain a good balance between sensitivity and speed. A direct extension of discrete-valued seeds to continuous values is to consider values that are close to each other (as defined by the C_{σ} bound) as matches. However, as mapping data typically have high error rates and represent short sequences (for example, on average, optical maps contain 10-22 fragments, representing roughly a 250 kbp region of the genome), a seed of c consecutive fragments (c-mer) is likely to have low sensitivity unless we use a naive c=1 approach (see FIG. 3 for a comparison) and pay a significant runtime penalty that scales with genome size. FIG. 3 shows a comparison of sensitivity between different seeding approaches for the human genome. FIG. 3a shows the easier scenario (A). FIG. 3b shows the harder scenario (B). For each corresponding length in fragments, we report the percentage of maps with at least one correct seed detected (out of 100 maps). Note that the approach used in OPTIMA, Composite seeds (iv), was able to find the correct location for more than 99% and 88% of maps with at least ten fragments in scenarios (A) and (B), respectively.

Therefore, we propose and validate the following composite seed extension for continuous-valued seeds, analogous to the work on spaced seeds for discrete-valued sequences (as outlined, for example in: Califano A. et al., Proc. of the 1^{st} International Conference on Intelligent Systems for Molecular Biology (ISMB 1993). Bethesda, Md., USA: AAAI; 1993, p. 56-64).

### Definition 4 (Composite Seed)

Let rⱼ₁, rⱼ₂ and rⱼ₃ be consecutive restriction fragments from a reference in silico map. A continuous-valued composite seed, for c=2, is given by including all of the following:

(i) the c-mer rⱼ₁, rⱼ₂, corresponding to no false cuts in the in silico map;
(ii) the c-mer rⱼ₁+rⱼ₂, rⱼ₃, corresponding to a missing cut in the experimental map (or false cut in the in silico map); and
(iii) the c-mer rⱼ₁, rⱼ₂+rⱼ₃, corresponding to a different missing cut in the experimental map (or false cut in the in silico map).

The reference index would then contain all c-tuples corresponding to a composite seed, as defined in Definition 4, for each location in the reference map. In addition, to account for false cuts in the experimental map, for each set of consecutive fragments oᵢ₁, oᵢ₂ and oᵢ₃ in the experimental maps, we search for c-tuples of the type oᵢ₁, oᵢ₂ and oᵢ₁+oᵢ₂; oᵢ₃ in the index (see Composite seeds (iv) depicted in FIG. 1c). FIG. 1c shows Composite seeds with c=2 (Definition 4), where Composite (iv) represents the final composition of seeds with errors used here; the case with one false cut allowed is not directly indexed from the in silico maps, but is explored during the seed search process.

To index the seeds, we adopt a straightforward approach where all c-tuples are collected and sorted into the same index in lexicographic order by c₁ (where the cᵢ are elements in the c-tuple). Lookups can be performed by binary search over fragment-sized intervals that satisfy the C_{σ} bound for c₁ and a subsequent linear scan of the other elements cᵢ, for i≥2, while verifying the C_{σ} bound in each case. Note that, because seeds are typically expected to be of higher quality, we can apply a more stringent threshold on seed fragment size matches (for example, we used C_{σ}^{seed}=2).

As will be shown below in the Results and discussion section, this approach significantly reduces the space of candidate alignments without affecting the sensitivity of the search. A comparison between the various seeding approaches is shown in FIG. 3, which highlights the advantages of composite seeds with respect to 2-mers.

Overall, the computational cost of finding seeds using this approach is O(m(log n+c #seeds_{c=1})) per experimental map, where n is the total length of the in silico maps in fragments, m<<n is the length of the experimental map and #seeds_{c=1} is the number of seeds found in the first level of the index lookup, before narrowing down the list to the actual number of seeds that will be extended (#seeds). The cost and space of creating the reference index is thus O(c n), if the number of errors considered in the composite seeds is limited and bounded (as in Definition 4), and radix sort is used to sort the index. This approach drastically reduces the number of alignments computed in comparison to more general, global alignment searches, as will be shown later in the Results and discussion section.

### Dynamic Programming-Based Extension of Seeds

In order to extend a seed to get a glocal alignment we adopt a scoring scheme similar to that used in SOMA (see Nagarajan N et al, Bioinformatics. 2008; 24:1229-1235). This allows us to evaluate alignments without relying on a likelihood-based framework that requires prior information on error distributions as input. In addition, we can use dynamic programming to efficiently find glocal alignments that optimize this score and contain the seed (see FIG. 1d which shows seed extension in glocal alignment with dynamic programming (straight lines delimit feasible matches found, dashed lines mark truncated end matches and dashed circles show potentially missing fragments)); specifically, for each seed side we proceed along the dynamic programming matrix by aligning the end of the sth experimental fragment with the end of the tth in silico fragment using backtracking to find feasible matches, that is, those that satisfy Equation 1 and minimize the total number of cut errors (#cuterrors=missing cuts+false cuts+missing fragments found), with ties being broken by minimizing a χ² function for fragment sizing errors:

$${Score}_{s , t} = {min}_{k \leq s , l \leq t} {C}_{cc} ( s - k + t - l ) - {x}_{k…s , l…t}^{2} + {Score}_{k - 1 , l - 1} . \qquad ( 2 )$$

where the first index of each subscript represents experimental fragments, the second index represents the in silico fragments, s-k is the number of false cuts, t-l is the number of missing cuts, C_{ce} is a constant larger than the maximum possible total for

$${x}^{2} \cdot {x}_{k…s , l…t}^{2} = {( {\sum }_{i = k}^{s} {o}_{i} - {\sum }_{j = l}^{t} {r}_{j} )}^{2} \text{/} ( {\sum }_{j = l}^{t} {σ}_{j}^{2} ) and {Score}_{0.0} = 0. {Score}_{i , 0} = x and {Score}_{0 , j} = x .$$

Note that a small in silico fragment is considered as missing if this condition allows for a valid alignment that improves the local χ² on nearby matches by half (up to three consecutive fragments).

As in Anantharaman T S et al. (Genomics via Optical Mapping III: Contiging Genomic DNA. In; Proceedings of the 7^{th} International Conference on Intelligent Systems for Molecular Biology (ISMB 1999). Heidelberg, Germany: AAAI; 1999 p. 18-27), we band the dynamic programming and its backtracking to avoid unnecessary computation. In particular, as we show in Supplementary Note 1 (see below), based on parameter estimates for optical mapping data, restricting alignments to eight missing cuts or five false cuts, consecutively, should retain high sensitivity. In addition, we stop the dynamic programming-based extension if no feasible solutions can be found for the current seed after having analyzed at least f fragments (default of five).

The computational cost of extending a seed (c-tuple) of an experimental map with m fragments is thus, in the worst case, O((m−c)δ³) time, where δ is the bandwidth of the dynamic programming, and O((m−c)²) space for allocating the dynamic programming matrix for each side of the seed.

### Statistical Significance and Uniqueness Analysis

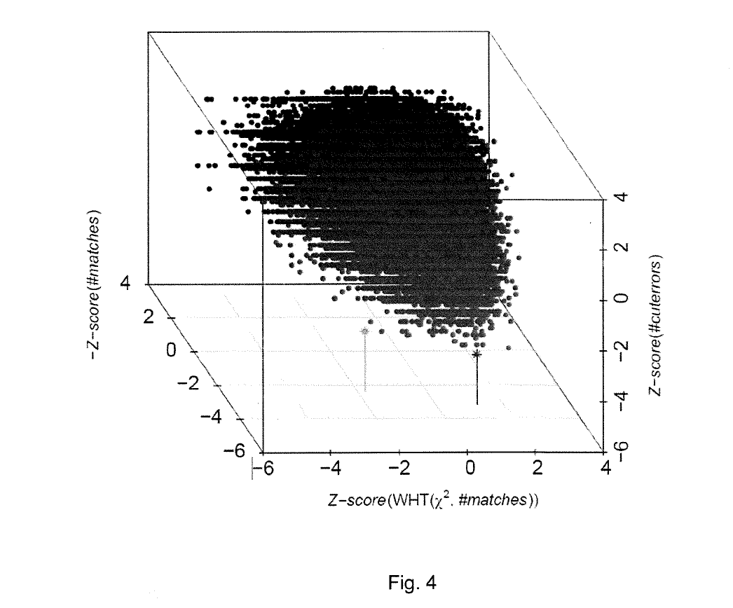

To evaluate the statistical significance of a candidate alignment, we exploit the fact that we have explored the space of feasible alignments in our search and use these alignments to approximate a random sample from a (conservative) null model. The assumption here is that there is only one true alignment and that, therefore, the population of these sub-optimal alignments can provide a conservative null model for evaluating the significance of an alignment; more specifically, for each candidate alignment found, we compute its distance from the null model in a feature space (to be defined later) using a Z-score transformation and then use this score to evaluate whether it is optimal, statistically significant and unique (see FIG. 4 for an example).

In FIG. 4, which displays a representation of candidate alignments as a function of alignment features, the results shown are based on aligning a 26-fragment simulated experimental map on the human reference genome. The green comet represents the true solution, and also the best solution π* found by OPTIMA (p-value p*=2.16e⁻⁹), while the blue comet belongs to a false alignment with the lowest number of cut errors (p=7.35e⁻⁶). Note here that despite having many near-optimal solutions, OPTIMA unambiguously identified the correct solution based on its statistical analysis.

We start by identifying a set F of features, independent with respect to false positive (or random) alignments, that are expected to follow the normal distribution (for example, using the central limit theorem) and be comparable between different alignments of the same experimental map, and we compute a Z-score for each feature f∈F and for each candidate solution π∈Π identified through the seeding method. Each Z-score takes into account the mean and standard deviation of a particular feature f among all candidate alignments found:

$$Z \text{-} score = ( π ∈ Π , f ) = \frac{{f}_{π} - Mean ( {f}_{Π} )}{SD ( {f}_{Π} )} . \qquad ( 3 )$$

Accounting for all considered features fᵢ, with 1≤i≤k and k≥2, the resulting score is given by:

$$ϑ ( π ∈ Π ) = Z \text{-} score ( {\sum }_{i} {s}_{i} \times Z \text{-} score ( π , {f}_{i} ) ) . \qquad ( 4 )$$

where sᵢ=1 if lower values of feature fᵢ are preferable and −1 otherwise, and the corresponding p-value is p_{π}=Pnorm(ϑ(π)), that is, the probability that a ‘random’ Z-score will be less than ϑ(η) under the standard normal distribution.

In our case, we chose a set of features based on the number of matches (#matches), the total number of cut errors and the Wilson-Hilferty transformation (WHT) of the χ² score for sizing errors (which converges quickly to a standard normal distribution):

$$WHT ( {x}^{2} , \# matches ) = \frac{\sqrt[3]{\frac{{x}^{2}}{\# matches}} - ( 1 - \frac{1}{9} \frac{2}{\# matches} )}{\sqrt{\frac{1}{9} \frac{2}{\# matches}}} . \qquad ( 5 )$$

Note that this set can be shown to be composed of approximately independent features for false positive alignments (Z-score pairwise covariances between all features did not show a significant alteration of the final Z-scores when accounting for them in all of our simulations). By the central limit theorem, the mean of the first two features can be approximated by the normal distribution when the number of candidate solutions is large enough (typically, greater than 60 distinct solutions), and, by Slutsky's theorem, their sample variance would not have a significant effect on the distribution of the test statistics. As lower values of #cuterrors and WHT(χ²,#matches) indicate better solutions, while a higher number of matches represents more reliable alignments, we need to adjust the signs of their Z-scores accordingly. The final Z-score ϑ(π) computed for each candidate solution π is therefore given by:

ϑ(π∈Π)=Z-score(−Z-score(π,#matches)+Z-score(π,#cuterrors)+Z-score(π,WHT(χ²,#matches))), (6)

which can be subsequently converted into the p-value p_{π}. The candidate solution π* with the lowest p-value p* is reported as the optimal solution, as shown in FIG. 4.

The statistical significance of the optimal solution can then be assessed through a false discovery rate q-value analysis (see, e.g. Storey J D et al., “Statistical significance for genomewide studies. Proceedings of the National Academy of Science. 2003; 100:9440-9445) based on all candidate solutions found for comparable experimental maps, for example, those with the same number of fragments (default of q=0.01). To assess uniqueness, we set a threshold on the ratio of p-values between the best solution and the next-best solution (default of five). See Supplementary Note 2 below for further algorithmic details.

In summary, our statistical scoring approach finds an optimal solution and evaluates its statistical significance and uniqueness in a unified framework, thus allowing for savings in computational time and space compared to a permutation test, without restricting the method to a scenario where experimental error probabilities are known a priori.

### Extension to Overlap Alignment

To extend OPTIMA to compute and evaluate overlap alignments—a key step in assembly pipelines that use mapping data (e.g., Dong Y. et al., Nature Biotechnology. 2013; 31:135-141; Ganapathy G. et al., GigaScience. 2014; 3:11; Kawahara Y et al., Improvement of the Oryza sativa Nipponbare reference genome using next generation sequence and optical map data. Rice. 2013; 6:4)—we use a sliding-window approach based on OPTIMA. This allows us to continue using the statistical evaluation procedure defined in OPTIMA that relies on learning parameters from comparable alignments (that is, those with the same number, size and order of experimental fragments) in a setting where the final alignments are not always of the same length and structure.

Briefly, for each map, OPTIMA-Overlap first finds optimal sub-map alignments, evaluates their significance and uniqueness, and then tries to extend the candidate alignments found until it reaches the ends of either the experimental map or the in silico map, in order to choose the most significant overlap alignments (see FIG. 1e).

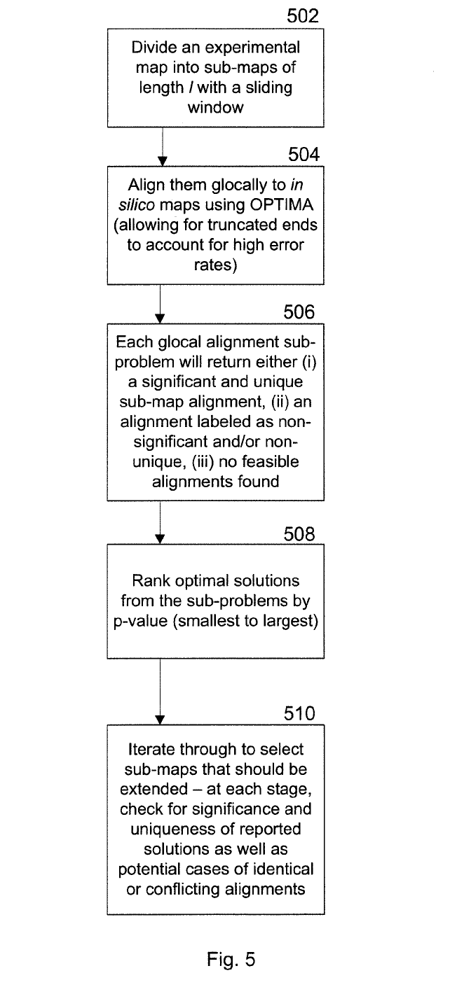

FIG. 5 shows a flowchart of this approach. The approach begins by dividing an experimental map into sub-maps of length l with a sliding window (step 502) and then glocally aligning them to in silico maps using OPTIMA (again allowing for truncated ends to account for high error rates) (step 504).

At step 506, each glocal alignment sub-problem will then return either:
(i) a significant and unique sub-map alignment;
(ii) an alignment labeled as non-significant and/or non-unique (which will be considered as a false alignment); or
(iii) no feasible alignments found.

At step 508, optimal solutions to the sub-problems are then ranked by p-value (smallest to largest) and iterated through to select sub-maps that should be extended (step 510). At each stage we check the significance and uniqueness of the reported solutions (compared to the others), as well as checking for potential cases of identical or conflicting alignments as defined below.

### Definition 5 (Conflicting Alignments)

A sub-map alignment π₁ is said to be conflicting with another alignment π₂ if either:
(a) the sub-map of π₁ overlaps the sub-map of π₂; or
(b) π₁ aligns to the same in silico map as π₂, but in a different location or strand.

Conflicting alignments can result in ambiguous placement of an experimental map on a database of in silico maps, but condition (a) could be relaxed in some cases, for example, when experimental maps are known to overlap multiple in silico maps in the same region. Therefore, while iterating through the list of sub-maps, the following rules are implemented:

1. Significance: if the current solution 7 is labeled as a false alignment, then we stop iterating through the rest of the list.

2. Uniqueness: we skip an alignment if either: (i) πᵢ represents the same overlap alignment as a more significant solution; (ii) πᵢ is conflicting with a solution with a lower p-value (that is, seen before); or (iii) πᵢ is not unique with respect to other solutions n with j>i (that is, having greater p-values) that it is conflicting with.

3. Extension with dynamic programming: optimal overlap solutions are identified according to Equation 2, where ties are broken in favor of longer valid alignments.

This approach allows us to report multiple overlap alignments (including split alignments) for an experimental map while using the q-value analysis, as before, to report all alignments with q≤0.01. For the q-value analysis, we consider all candidate solutions found for the sliding windows in order to learn the q-value parameters. In addition, we can reuse the dynamic programming matrix computed for each seed across sub-map alignments and thus complete the overlap alignment with the same asymptotic time and space complexity as the glocal alignment.

### Generation of Benchmarking Datasets

To benchmark OPTIMA and OPTIMA-Overlap against other state-of-the-art map aligners, we first developed synthetic datasets that aim to represent two ends of the spectrum of errors in mapping data for eukaryotic genomes. These scenarios were defined by confidently aligning (using SOMA (see Nagarajan N et al., Scaffolding and validation of bacterial genome assemblies using optical restriction maps. Bioinformatics. 2008; 24:1229-235) and manual curation) two sets of maps from different experimental runs for optical mapping (using the Argus system from OpGen) on a human cell line. The first scenario, (A), was defined based on lanes that were reported by the Argus machine to have high quality scores, while the second scenario, (B), was defined by lanes with the lower qualities that were typically obtained on the system. We estimated three key parameters from the data: d, the average restriction enzyme digestion rate; f₁₀₀, the average false cut rate per 100 kbp; and the fragment sizing errors for predefined (reference) in silico fragment size ranges (these were fixed for both scenarios and recorded as relative deviations of the empirical sizes from the reference sizes):
(A) Easier scenario: d=0.78 (corresponding to missing cut rate of 22%); f₁₀₀=0.97; and probability at 0.5 for missing fragments of size below 1.2 kbp, 0.75 below 600 bp and 1 below 350 bp.
(B) Harder scenario: d=0.61 (corresponding to missing cut rate of 39%); f₁₀₀=1.38; 0.5 for missing fragments of size below 2 kbp, 0.75 below 800 bp and 1 below 350 bp.
   For each scenario, we first simulate the map sizes using empirically derived distributions from real maps (average size of approximately 275 kbp, containing 17 fragments) and extract the corresponding reference sub-maps by sampling start locations uniformly from the in silico maps (possibly creating truncated end fragments). Then we introduce cut errors using the probability distributions described in (Valouev A et al., Alignment of Optical Maps. Journal of Computational Biology. 2006; 13:442-462) with the above parameters, that is: first, we remove missing cuts following a Binomial distribution with probability 1−d; next, we insert false cuts modelled as a Poisson process with rate f₁₀₀ (avoiding creation of small fragments less than 1.2 kbp in size); and finally, we remove small fragments with the probabilities described above. Sizing errors are introduced by sampling from the empirical errors found for each range of reference fragment sizes. Simulated experimental maps smaller than 150 kbp or with fewer than ten fragments are discarded, mimicking the pre-processing stage on the Argus system.

We generated 100 times greater coverage of maps with errors for the Drosophila melanogaster (BDGP 5) and Homo sapiens (hg19/GRCh37) genomes using the KpnI restriction pattern GGTAC′C, where the apostrophe indicates the position of the cut, which resulted in 13,920 fragments genome-wide (forward and reverse strands) with an average fragment size (AFS) of 17.3 kbp and 573,276 fragments with AFS=10.8 kbp, respectively.

### Glocal Alignment Results

OPTIMA was compared against the state-of-the-art algorithms Gentig v.2 (alignment module) (Anantharaman T S et al., Genomics via Optical Mapping II: Ordered Restriction Maps. Journal of Computational Biology. 1997; 4:91-118; Anantharaman T S et al., Geconomics via Optical Mapping III: Contiging Genomic DNA. In: Proceedings of the 7th International Conference on Intelligent Systems for Molecular Biology (ISMB 1999). Heidelberg, Germany: AAAI; 1999. p. 18-27; Anantharaman T S et al., Fast and Cheap Genome Wide Haplotype Construction via Optical Mapping. In: Altman R B et al; editors. Proceedings of the 10th Pacific symposium on Biocomputing (PSB 2005). Hawaii, USA: World Scientific; 2005. p. 1-16), SOMA v.2 (Nagarajan N, et al., Scaffolding and validation of bacterial genome assemblies using optical restriction maps. Bioinformatics. 2008; 24:1229-1235) and Valouev's likelihood-based fit alignment (Valouev A et al., Alignment of Optical Maps. Journal of Computational Biology. 2006; 13:442-462) for glocally aligning the simulated maps over their respective in silico reference genomes. TWIN (Muggli M D et al., Efficient Indexed Alignment of Contigs to Optical Maps. In: Algorithms in Bioinformatics (WABI 2014). vol. 8701 of LNCS. Wroc law, Poland: Springer; 2014. p. 68-81) was not included in this comparison as it does not allow for errors and missing information in experimental maps.

We also ran variations of these algorithms from their default options (d): specifically, by providing the true error distribution parameters used in the simulations as input (tp), the adjusted AFS based on the organism under analysis (a) and parameter values published in the respective papers (instead of the software's default ones), to provide, in addition, the true error distribution rates (p); and by allowing the trimming of map ends in the alignment (t). Moreover, SOMA (Nagarajan N, et al., Scaffolding and validation of bacterial genome assemblies using optical restriction maps. Bioinformatics. 2008; 24:1229-1235) was modified to correctly handle missing in silico fragments up to 2 kbp, to run only for C_{σ}=3, to make its results comparable, and by inverting the role of in silico-experimental input maps (v). We omitted SOMA's statistical test (also for Valouev's likelihood method, where it is not enabled by default), because it is unfeasible for large datasets (Muggli M D, Puglisi S J, Boucher C. Efficient Indexed Alignment of Contigs to Optical Maps. In: Algorithms in Bioinformatics (WABI 2014). vol. 8701 of LNCS. Wroc law, Poland: Springer; 2014. p. 68-81), and applied only its uniqueness test (F-test). Further details about the running parameters are provided in Supplementary Note 3 below. OPTIMA alignments were performed on both strands of the in silico maps, without trimming end fragments or removing any small in silico fragments.

TABLE 1
Comparison of all methods and their variants on glocal
map-to-sequence alignment.

| | Drosophila | | Drosophila | | Human | | Human | |
|---|---|---|---|---|---|---|---|---|
| | (A) | | (B) | | (A) | | (B) | |
| Algorithm | S | P | S | P | S | P | S | P |
| OPTIMA | 90 | 100 | 49 | 99 | 83 | 100 | 43 | 98 |
| Gentig v.2 (d) | 59 | 100 | 24 | 99 | 53 | 96 | 20 | 80 |
| Gentig v.2 (tp) | 59 | 100 | 24 | 98 | 54 | 95 | 20 | 88 |
| SOMA v.2 (v) | 72 | 73 | 31 | 39 | 50 | 50 | 17 | 20 |
| Likelihood | 49 | 49 | 29 | 30 | 24 | 24 | 14 | 14 |
| (d + a) | | | | | | | | |
| Likelihood | 64 | 65 | 38 | 39 | 33 | 34 | 18 | 19 |
| (d + a + t) | | | | | | | | |
| Likelihood | 75 | 75 | 39 | 39 | 62 | 62 | 19 | 20 |
| (p + a + t) | | | | | | | | |

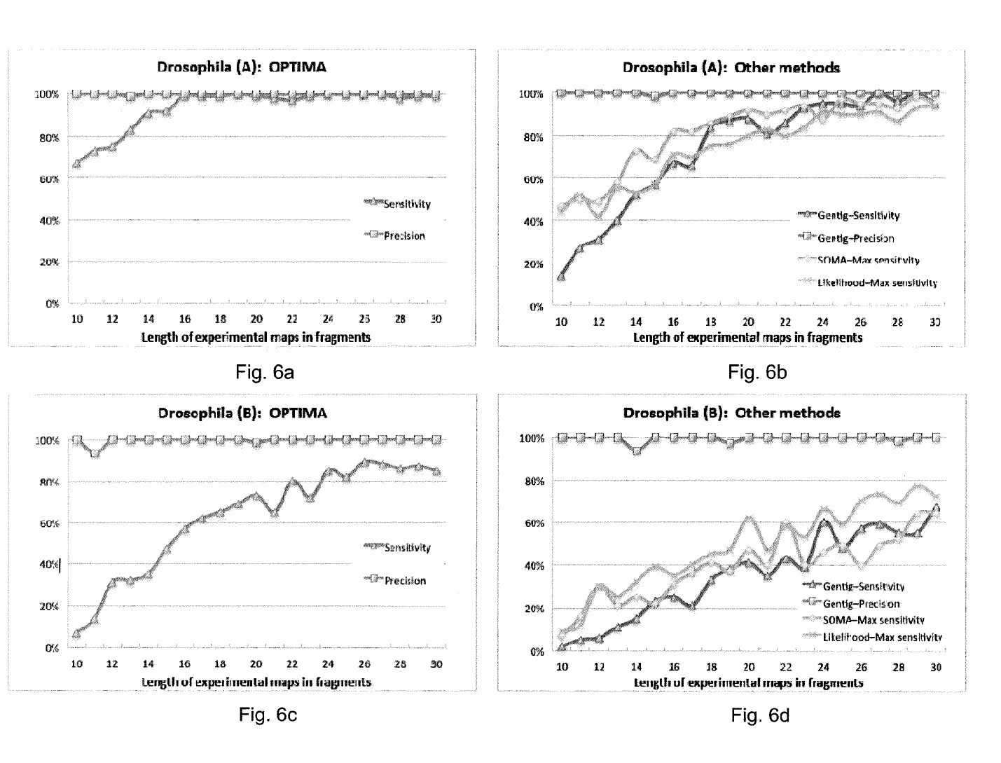

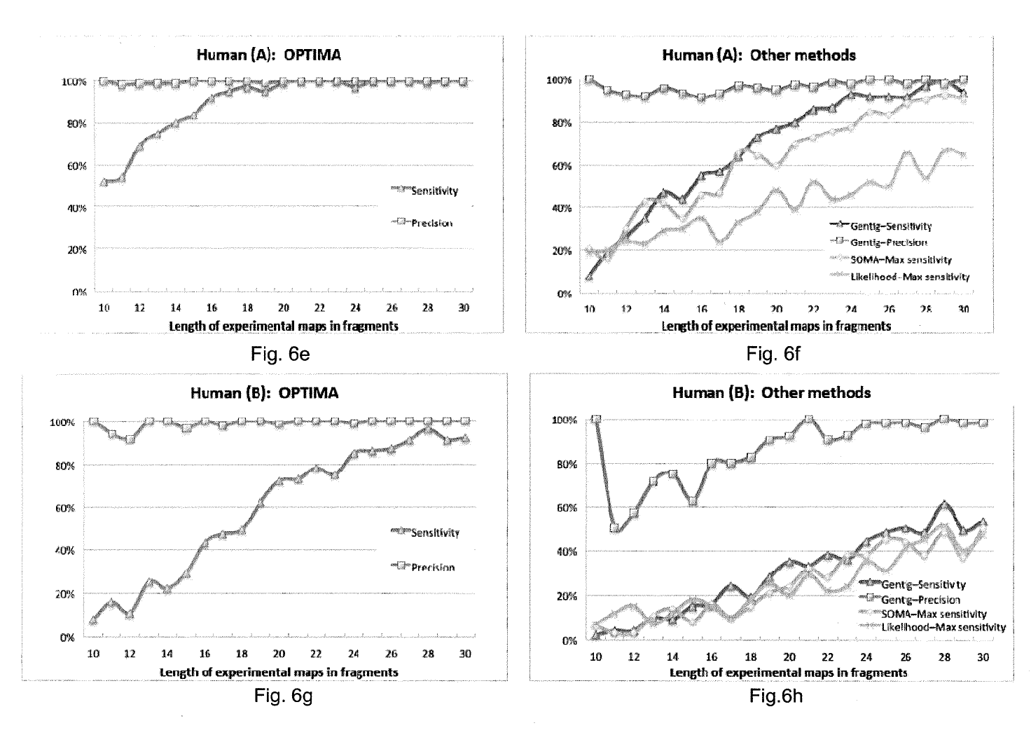

Sensitivity (S) and precision (P) are percentages and the best values across all methods are highlighted in bold. Results are based on the alignment of a subset of 2,100 maps, as used in FIG. 6.

As can be seen from the results in Table 1, OPTIMA reports alignments with very high precision, greater than 99% in most cases, independent of the genome size and the dataset error rate. In comparison, Gentig has similarly high precision on the Drosophila genome but lower precision on the human genome, with as low as 80% precision under scenario (B) (with default parameters). Without their computationally expensive statistical tests, which can increase the runtime by a factor of greater than 100, SOMA and the likelihood-based method have much lower precision, particularly on the human genome. In addition, in terms of sensitivity, OPTIMA was found to be notably better than other aligners, even when the true error distribution rates were provided as input to these algorithms. In particular, for the higher quality scenario (A), OPTIMA is more than 1.5 times as sensitive as Gentig, and for the commonly obtained scenario (B), OPTIMA is more than twice as sensitive as Gentig.

These results are further broken down in FIG. 6, which shows glocal alignment as a function of the number of fragments in the experimental maps. Gentig results are plotted for setting (d) and likelihood-based fit alignment results are for setting (d+a+t). Results are reported for 100 maps for each bin of simulated datasets for Drosophila and human scenarios (A) and (B).

In FIG. 6, results are broken down as a function of the number of fragments in the experimental maps, showing that OPTIMA uniformly achieves more than twice the sensitivity for the smaller maps that are frequently obtained in real datasets. The relatively higher sensitivities of SOMA and the likelihood-based method in these experiments are likely to be artefacts of relaxed settings in the absence of their statistical tests. These results highlight OPTIMA's high precision and improved sensitivity across experimental conditions and suggest that it could adapt well to other experimental settings.

In Table 2 (see below), we further compare all methods on their running time and worst-case complexity (runtime and space). It can be seen that SOMA and the likelihood-based methods are at least an order of magnitude slower than OPTIMA and Gentig. Gentig's proprietary algorithm is based on work that has been previously published (Anantharaman T S et al., Genomics via Optical Mapping III: Contiging Genomic DNA. In: Proceedings of the 7th International Conference on Intelligent Systems for Molecular Biology (ISMB 1999). Heidelberg, Germany: AAAI; 1999. p. 18-27. Anantharaman T S et al., Fast and Cheap Genome Wide Haplotype Construction via Optical Mapping. In: Altman R B, Jung T A, Klein T E, Dunker A K, Hunter L, editors. Proceedings of the 10th Pacific Symposium on Biocomputing (PSB 2005). Hawaii, USA: World Scientific; 2005. p. 1-16), but its current version uses an unpublished hashing approach. In comparison, OPTIMA is two times faster while being more than 50% more sensitive than Gentig.

TABLE 2
Running time and worst-case complexity for various glocal map-to-sequence aligners.

| | Complexity | | Running time | | | |
|---|---|---|---|---|---|---|
| Algorithm | Time | Space | Drosophila | | Human | |
| OPTIMA | O((m − c) δ³ #seeds) | O((m − c)² + cn) | 54 | m | 36 | days |
| Gentig v.2 (d) | O(#it m δ³ #hashes) | O(m² + n + \|HashTable\|) | 1.32 | h | 75 | days |
| Gentig v.2 (tp) | | | 1.85 | h | 174 | days |
| SOMA v.2 (v) | O(m² n²) | O(m n) | 1.28 | years | 1,067 | years |
| Likelihood (d + a) | | | 22.22 | h | 2.72 | years |
| Likelihood (d + a + t) | O(m n δ²) | O(m n) | 19.62 | h | 2.38 | years |
| Likelihood (p + a + t) | | | 41.73 | h | 5.53 | years |

Running times reported are estimated from 2,100 maps and extrapolated for the full datasets (82,000 Drosophila maps and 2.1 million human maps, for 100× coverage; single-core computation on Intel x86 64-bit Linux workstations with 16 GB RAM). The best column-wise running times are reported in bold. Note that including the permutation-based statistical tests for SOMA and the likelihood method would increase their runtime by a factor of greater than 100. The complexity analysis refers to map-to-sequence glocal alignment per map, where n is the total length of the in silico maps (˜500,000 fragments for the human genome), m<<n is the length of the experimental map in fragments (typically 17 fragments on average), #seeds, c (default of two) and 5 are as defined in the methods section and #it (number of iterations), #hashes (geometric hashes found to match) and |HashTable| are as specified in [17, 24].

[17]: Anantheraman T S et al., Genomics via Optical Mapping III: Contiging Genomic DNA. In: Proceedings of the 7th International Conference on Intelligent Systems for Molecular Biology (ISMB 1999). Heidelberg, Germany: AAAI; 1999. p. 18-27.

[24]: Anantharaman T S et al., Fast and Cheap Genome Wide Haplotype Construction via Optical Mapping. In: Altman R B, Jung T A, Klein T E, Dunker A K, Hunter L, editors. Proceedings of the 10th Pacific Symposium on Biocomputing (PSB 2005). Hawaii, USA: World Scientific; 2005. p. 1-16.

### Real Data Analysis and Comparison

To assess OPTIMA's performance on real data we generated, in-house, 309,879 and 296,217 optical maps for two human cell lines, GM12878 and HCT116, respectively, using the Argus system from OpGen (Dong Y et al. Sequencing and automated whole-genome optical mapping of the genome of a domestic goat (Capra hircus). Nature Biotechnology. 2013; 31:135{141. Teo A S M et al. Single-molecule optical genome mapping of a human HapMap and a colorectal cancer cell line. Giga Science. 2016-5) (with the KpnI enzyme and ten map cards in total), and glocally aligned them over the human reference genome. Supplementary Note 4 (see below) provides the sizing error statistics.

TABLE 3
Statistics for glocal alignment of real human optical maps from GM12878
HapMap cell line.

| | | | | | | Increase | | | | | Avg. WHT |
|---|---|---|---|---|---|---|---|---|---|---|---|
| | | | | | | w.r.t. | Yield | Avg. | Avg. | Avg. | chi square |
| | | Input | | | Gentig | Gentig | (genome | length | digestion | false/extra | sizing |
| Map card | F | maps | Details | OPTIMA | v.2 | v.2 | coverage) | and size | rate | cut rate | error |
| 21157LB | (r) | 73,365 | Avg. quality 0.50; | 25% | 9% | 3X | 2X | 21 f \| 324 kbp | 66% | 0.74 | −0.69 |
| | | (7.2X) | size 295 kbp, 18 f; | | | | | | | | |
| | | | AFS 16.5 kbp | | | | | | | | |
| | (s) | 38,483 | Avg. quality 0.53; | 36% | 14% | 2.6X | 1.7X | 23 f \| 361 kbp | 65% | 0.73 | −0.58 |
| | | (4.7X) | size 368 kbp, 22 f; | | | | | | | | |
| | | | AFS 17 kbp | | | | | | | | |
| 21159LB | (r) | 75,761 | Avg. quality 0.47; | 19% | 5% | 4X | 1.6X | 19 f \| 325 kbp | 63% | 0.72 | −1.07 |
| | | (7.6X) | size 300 kbp, 17 f; | | | | | | | | |
| | | | AFS 17.4 kbp | | | | | | | | |
| | (s) | 41,236 | Avg. quality 0.50; | 27% | 8% | 3.4X | 1.3X | 21 f \| 359 kbp | 62% | 0.72 | −0.97 |
| | | (5.1X) | size 370 kbp, 21 f; | | | | | | | | |
| | | | AFS 17.8 kbp | | | | | | | | |
| 21431LB | (r) | 93,896 | Avg. quality 0.52; | 20% | 8% | 2.6X | 1.9X | 21 f \| 305 kbp | 68% | 0.77 | −0.42 |
| | | (8.6X) | size 274 kbp, 17 f; | | | | | | | | |
| | | | AFS 15.8 kbp | | | | | | | | |
| | (s) | 43,667 | Avg. quality 0.54; | 30% | 13% | 2.4X | 1.5X | 23 f \| 343 kbp | 67% | 0.77 | −0.29 |
| | | (5.1X) | size 348 kbp, 21 f; | | | | | | | | |
| | | | AFS 16.3 kbp | | | | | | | | |
| 21443LB | (r) | 66,857 | Avg. quality 0.51; | 19% | 7% | 2.7X | 1.3X | 20 f \| 299 kbp | 67% | 0.77 | −0.50 |
| | | (6X) | size 271 kbp, 17 f; | | | | | | | | |
| | | | AFS 15.8 kbp | | | | | | | | |
| | (s) | 29,991 | Avg. quality 0.53; | 29% | 12% | 2.5X | 1X | 23 f \| 340 kbp | 66% | 0.77 | −0.35 |
| | | (3.5X) | size 346 kbp, 21 f; | | | | | | | | |
| | | | AFS 16.3 kbp | | | | | | | | |
| TOTAL | (r) | 309,879 | Avg. quality 0.50; | 21% | 7% | 2.9X | 6.8X | 21 f \| 314 kbp | 66% | 0.75 | −0.66 |
| | | (29.4X) | size 285 kbp, 17 f; | | | | | | | | |
| | | | AFS 16.4 kbp | | | | | | | | |
| | (s) | 153,377 | Avg. quality 0.52; | 31% | 11% | 2.7X | 5.5X | 23 f \| 352 kbp | 65% | 0.75 | −0.55 |
| | | (18.3X) | size 359 kbp, 21 f; | | | | | | | | |
| | | | AFS 16.9 kbp | | | | | | | | |

In table 3, statistics are reported independently for each map card of GM12878 cell line, using: (r) relaxed filtering: ≥10 fragments and 150 kbp; and (s) stringent filtering: ≥12 fragments and 250 kbp (as shown in column F). From left to right are reported: the total number of input maps and their coverage in bases of the human genome; further details such as average map quality (provided by the Argus machine), average map size in bases and length in fragments, and average fragment size (AFS); aligned maps by OPTIMA and Gentig v.2; OPTIMA alignment rate increase with respect to Gentig v.2; other OPTIMA alignment statistics.

TABLE 4
Statistics for glocal alignment of real human optical maps from HCT116
colorectal cancer cell line.

| | | | | | | Increase | | | | | Avg. WHT |
|---|---|---|---|---|---|---|---|---|---|---|---|
| | | | | | | w.r.t. | Yield | Avg. | Avg. | Avg. | chi square |
| | | | | | Gentig | Gentig | (genome | length | digestion | false/extra | sizing |
| Map card | F | Input maps | Details | OPTIMA | v.2 | v.2 | coverage) | and size | rate | cut rate | error |
| 17182LA | (r) | 10,911 | Avg. quality 0.33; | 4% | 0.5% | 8.1X | 0.04X | 19 f \| 245 kbp | 66% | 1.29 | −1.15 |
| | | (0.9X) | size 257 kbp, 150; | | | | | | | | |
| | | | AFS 15.7 kbp | | | | | | | | |
| | (s) | 3,744 | Avg. quality 0.33; | 4% | 0.9% | 4.5X | 0.02X | 22 f \| 326 kbp | 63% | 1.23 | −0.83 |
| | | (0.4X) | size 351 kbp, 200; | | | | | | | | |
| | | | AFS 17.7 kbp | | | | | | | | |
| 17184LA-2 | (r) | 55,719 | Avg. quality 0.43; | 18% | 9% | 1.9X | 1.1X | 23 f \| 332 kbp | 68% | 0.76 | −0.65 |
| | | (5.7X) | size 305 kbp, 190; | | | | | | | | |
| | | | AFS 16.3 kbp | | | | | | | | |
| | (s) | 28,658 | Avg. quality 0.45; | 25% | 15% | 1.6X | 0.9X | 25 f \| 378 kbp | 67% | 0.74 | −0.51 |
| | | (3.7X) | size 390 kbp, 23 f; | | | | | | | | |
| | | | AFS 17.2 kbp | | | | | | | | |
| 17185LA | (r) | 56,879 | Avg. quality 0.55; | 24% | 18% | 1.4X | 1.5X | 23 f \| 325 kbp | 70% | 0.76 | −0.17 |
| | | (5.4X) | size 285 kbp, 191; | | | | | | | | |
| | | | AFS 14.7 kbp | | | | | | | | |
| | (s) | 28,003 | Avg. quality 0.59; | 35% | 28% | 1.2X | 1.2X | 26 f \| 367 kbp | 70% | 0.74 | −0.04 |
| | | (3.4X) | size 365 kbp, 24 f; | | | | | | | | |
| | | | AFS 15.1 kbp | | | | | | | | |
| 17186LA-3 | (r) | 52,984 | Avg. quality 0.54; | 33% | 19% | 1.7X | 2X | 24 f \| 342 kbp | 70% | 0.68 | −0.35 |
| | | (5.8X) | size 328 kbp, 200; | | | | | | | | |
| | | | AFS 16.0 kbp | | | | | | | | |
| | (s) | 31,588 | Avg. quality 0.56; | 42% | 28% | 1.5X | 1.7X | 26 f \| 380 kbp | 69% | 0.67 | −0.26 |
| | | (4.3X) | size 404 kbp, 250; | | | | | | | | |
| | | | AFS 16.4 kbp | | | | | | | | |
| 17187LA | (r) | 88,730 | Avg. quality 0.45; | 12% | 7% | 1.7X | 1X | 21 f \| 285 kbp | 69% | 0.94 | −0.56 |
| | | (7.8X) | size 264 kbp, 180; | | | | | | | | |
| | | | AFS 14.8 kbp | | | | | | | | |
| | (s) | 36,018 | Avg. quality 0.46; | 17% | 11% | 1.6X | 0.7X | 24 f \| 338 kbp | 68% | 0.92 | −0.35 |
| | | (4.2X) | size 349 kbp, 220; | | | | | | | | |
| | | | AFS 15.8 kbp | | | | | | | | |
| 14593LB | (r) | 30,994 | Avg. quality 0.39; | 6% | 0.6% | 9.9X | 0.2X | 16 f \| 269 kbp | 63% | 0.85 | −1.23 |
| | | (2.7X) | size 261 kbp, 140; | | | | | | | | |
| | | | AFS 18.9 kbp | | | | | | | | |
| | (s) | 10,944 | Avg. quality 0.39; | 9% | 0.7% | 12.3X | 0.1X | 18 f \| 320 kbp | 60% | 0.87 | −0.97 |
| | | (1.2X) | size 337 kbp, 170; | | | | | | | | |
| | | | AFS 20.2 kbp | | | | | | | | |
| TOTAL | (r) | 296,217 | Avg. quality 0.47; | 18% | 11% | 1.7X | 5.7X | 23 f \| 322 kbp | 69% | 0.77 | −0.44 |
| | | (28.3X) | size 287 kbp, 180; | | | | | | | | |
| | | | AFS 15.7 kbp | | | | | | | | |
| | (s) | 138,955 | Avg. quality 0.50; | 27% | 18% | 1.5X | 4.6X | 25 f \| 368 kbp | 68% | 0.75 | −0.28 |
| | | (17.2X) | size 372 kbp, 230; | | | | | | | | |
| | | | AFS16.5kbp | | | | | | | | |

Statistics are reported for each map card of HCT116 cell line using the relaxed filtering (r) and the stringent filtering (s), similarly as in Table 3. These results further suggest a mean yield of 1.25× and 1× for (r) and (s), respectively, in terms of aligned coverage of the human genome per map card using OPTIMA.

Table 3 and Table 4 (see above) report statistics of the alignments for raw maps filtered under two settings:
(r) relaxed filtering, which filters maps with fewer than ten fragments and smaller than 150 kbp;
(s) stringent filtering (as suggested in Dong Y et al., Sequencing and automated whole-genome optical mapping of the genome of a domestic goat (Capra hircus), Nature Biotechnology, 2013; 31:135-141), which filters maps with fewer than 12 fragments and smaller than 250 kbp.

The statistics were reported independently for each map card to capture the variability in terms of quality. In total, OPTIMA, with a stringent uniqueness threshold of 30, confidently aligned nearly three times as many maps as Gentig (with default parameters) for GM12878. Similarly, for HCT116, OPTIMA results were 1.7 times better than Gentig results, and corresponding improvements were also obtained using the stringently filtered datasets.

Further analyzing the error rates in the maps that OPTIMA confidently aligned Table 3 and Table 4), we observed that the overall statistics for average digestion rate d, false/extra cut rate f₁₀₀ and sizing errors were found to be similar to those obtained using scenario (B) (see Supplementary Note 5 below).

### Overlap Alignment Results

For overlap alignment, we compared OPTIMA-Overlap with an overlap-finding extension of Gentig v.2 (implemented in the commercial software Genome-Builder from OpGen, which contains a module called Scaffold Extender) (Anantharaman T S et al., Genomics via Optical Mapping III: Contiging Genomic DNA. In: Proceedings of the 7th International Conference on Intelligent Systems for Molecular Biology (ISMB 1999). Heidelberg, Germany: AAAI; 1999. p. 18-27. Anantharaman T S et al., Fast and Cheap Genome Wide Haplotype Construction via Optical Mapping. In: Altman R B, Jung T A, Klein T E, Dunker A K, Hunter L, editors. Proceedings of the 10th Pacific Symposium on Biocomputing (PSB 2005). Hawaii, USA: World Scientific; 2005. p. 1-16), as well as with Valouev's likelihood-overlap method (Valouev A. et al., Alignment of Optical Maps. Journal of Computational Biology. 2006; 13:442-462).

In our first test, we randomly selected 1,000 maps for each scenario (A) and (B) from our previously simulated maps for Drosophila (BDGP 5) and human (hg19/GRCh37) genomes. In addition, we simulated assembled sequence fragments for these genomes based on empirically derived scaffold size distributions (Drosophila assembly N50 of 2.7 Mbp with 239 scaffolds and human assembly N50 of 3.0 Mbp with 98,987 scaffolds); the simulated assemblies were used to generate in silico maps (filtered for those with fewer than four non-end fragments, because these cannot be confidently aligned (Anantharaman T S, Mishra B. A Probabilistic Analysis of False Positives in Optical Map Alignment and Validation. In: First International Workshop on Algorithms in Bioinformatics (WABI 2001). Aarhus, Denmark: Springer; 2001. p. 27-40. Sarkar D et al statistical Significance of Optical Map Alignments. Journal of Computational Biology. 2012; 19:478-492), which were then aligned with the simulated experimental maps.

For our second test, we compared all methods on optical mapping data generated in-house from the K562 human cancer cell line on OpGen's Argus system, where a random sample of 2,000 maps with at least ten fragments was extracted. In silico maps were generated from de novo assemblies of shotgun Illumina sequencing data (HiSeq) and six mate-pair libraries with insert sizes ranging from 1.1 kbp to 25 kbp (Yao F. et al., PLOS ONE. 2012; 7:e46152) (the final assembly had an N50 of 3.1 Mbp and 76,990 scaffolds in total, using SOAPdenovo v.1.05 (Li R et al., De novo assembly of human genomes with massively parallel short read sequencing. Genome Research. 2010; 20:265-22) with a k-mer size of 51 for contig assembly and Opera v.1.1 (Gao S et al Opera: Reconstructing Optimal Genomic Scaffolds with High-Throughput Paired-End Sequences. Journal of Computational Biology. 2011; 18:1681-1691) for scaffolding with mate pairs). It is likely that this dataset represents a harder scenario, with assembly gaps/errors and genomic rearrangements confounding the analysis. It also represents a likely use case where mapping data will be critical to detect large structural variations, disambiguate complex rearrangements and, ultimately, assemble cancer genomes de novo.

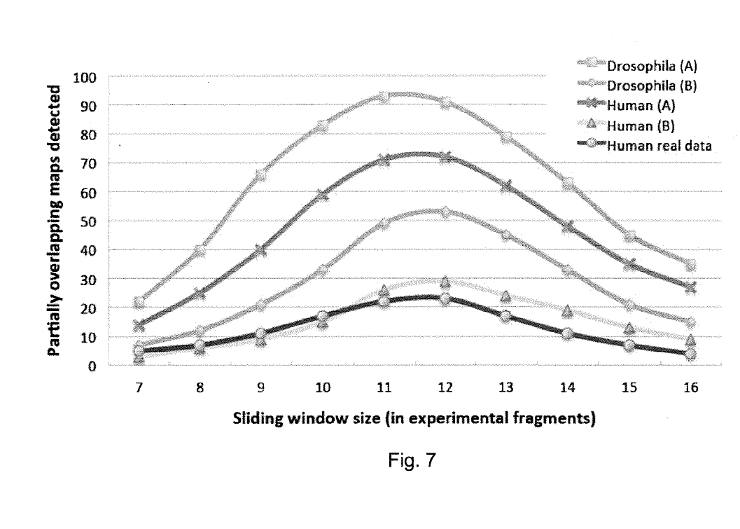

For each test, we evaluated the precision of alignments as well as the number of (correctly) reported alignments that provide an extension to the in silico maps through experimentally determined fragments, as this is key for the application of overlap alignments in genome assembly. We begin by noting that there is an important trade-off between sensitivity with a specific window size in OPTIMA-Overlap and the correctness of alignments, as can be seen in FIG. 7. As expected, even though small window sizes (less than ten in FIG. 7) provide more sensitive results, they also make true alignments indistinguishable from noise and reduce the number of correct alignments detected; on the other hand, larger window sizes improve the signal-to-noise ratio but result in a drop in sensitivity. This leads to a sweet spot in the middle (10-13 fragments) where the method is most sensitive across a range of datasets. In particular, real datasets are slightly more challenging than our simulations (see human (B) compared to real data in FIG. 7) and so we have conservatively chosen a window size of 12 as the default for OPTIMA-Overlap. By benchmarking OPTIMA-Overlap with this setting, we observed high precision similar to that observed with OPTIMA for glocal alignment (Table 5—see below). This was seen uniformly across datasets with disparate profiles in terms of genome size and error rates, suggesting that our statistical evaluation is reasonably robust. As before, we also note that Gentig's approach and the likelihood-based method might not always exhibit high precision. Finally, in terms of sensitivity, OPTIMA-Overlap shows a 30-80% improvement over competing approaches, and this is also seen in the harder real datasets.

TABLE 5
Comparison of methods for overlap map-to-sequence alignment.

| | Drosophila (A) | | Drosophila (B) | | Human (A) | | Human (B) | | Human real data |
|---|---|---|---|---|---|---|---|---|---|
| Algorithm | E | P | E | P | E | P | E | P | E |
| OPTIMA-Overlap | 91 | 100 | 53 | 98 | 72 | 99 | 29 | 97 | 23 |
| Gentig v.2 (d) | 69 | 100 | 29 | 93 | 51 | 93 | 19 | 83 | 14 |
| Likelihood-Overlap (d + a) | 59 | 74 | 36 | 52 | 21 | 41 | 9 | 26 | 12 |

The precision of overlap alignments (P, in percentages) and the number of overlap alignments that lead to (correct) extensions (E, absolute values) as a measure of sensitivity (correctness is only known for simulated datasets) are shown. The best values across methods are highlighted in bold.

### Utility in Real-World Applications

Overlap alignments form a critical building block for applications such as OpGen's Genome-Builder and its use in boosting assembly quality (Dong Y et al. Sequencing and automated whole-genome optical mapping of the genome of a domestic goat (Capra hircus). Nature Biotechnology. 2013; 31:135-141). As OPTIMA-Overlap can work with lower quality data (scenario (B) in our simulations; Genome-Builder would typically filter out such data) and also provide improved sensitivity in detecting overlap alignments, we estimate that its use could reduce the requirement Verzotto et al. Page 13 of 21 for generating mapping data by half. As the cost of mapping data for the assembly of large eukaryotic genomes can range from USD 20,000 to 100,000, this can lead to significant cost savings.

We similarly compared OPTIMA and Gentig on the two human cell line results, shown in Table 3 and Table 4, in order to calculate how much mapping data would be needed for sufficient aligned coverage of the human genome to enable structural variation analysis. By analyzing the alignment rate increase of OPTIMA compared to Gentig, a 1.5 to 2.9 times increase on average, we computed the corresponding cost reduction to be 33-66%, with an average cost reduction of 54% for relaxed filtering of data (r) and 49% for stringent filtering (s). These results suggest that for structural variation analysis on the human genome, particularly for cancer genomes, OPTIMA can significantly reduce project costs (in the tens of thousands of dollars) while enabling faster analyses of the data.

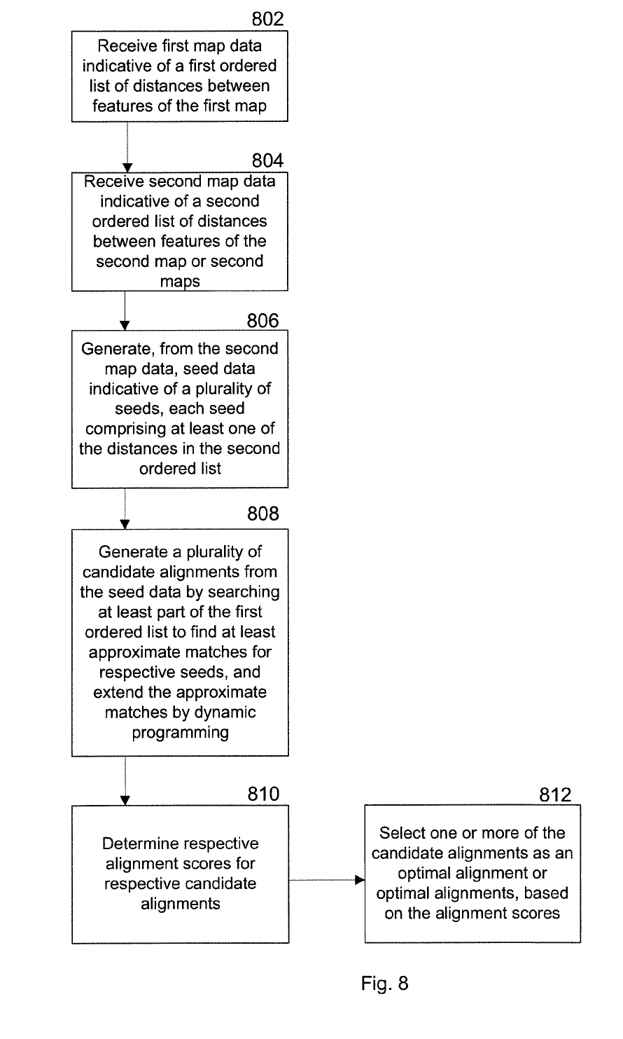

FIG. 8 shows a flowchart of an alignment method described herein for determining at least one optimal alignment of at least part of a first map to at least part of a second map or a plurality of second maps.

At step 802, first map data indicative of a first ordered list of distances between features of the first map is received. At step 804, second map data indicate of a second ordered list of distances between features of the second map or second maps is received.

It will be appreciated that steps 802 and 804 of the method may also be performed in reverse order or at the same time. Furthermore, the (first and) second map(s) may then be indexed before generating seed data from the second map data at step 806 as outlined below.

At step 806, seed data indicative of a plurality of seeds is generated from the second map data, wherein each seed comprises at least one of the distances in the second ordered list.

At step 808, a plurality of candidate alignments from the seed data is generated by searching at least part of the first ordered list to find at least approximate matches for respective seeds, and the approximate matches are extended by dynamic programming.

At step 810, respective alignment scores for respective candidate alignments are determined.

At step 812, one or more of the candidate alignments are selected as an optimal alignment or optimal alignments, based on the alignment scores, whereby the alignment scores may be compared to each other.

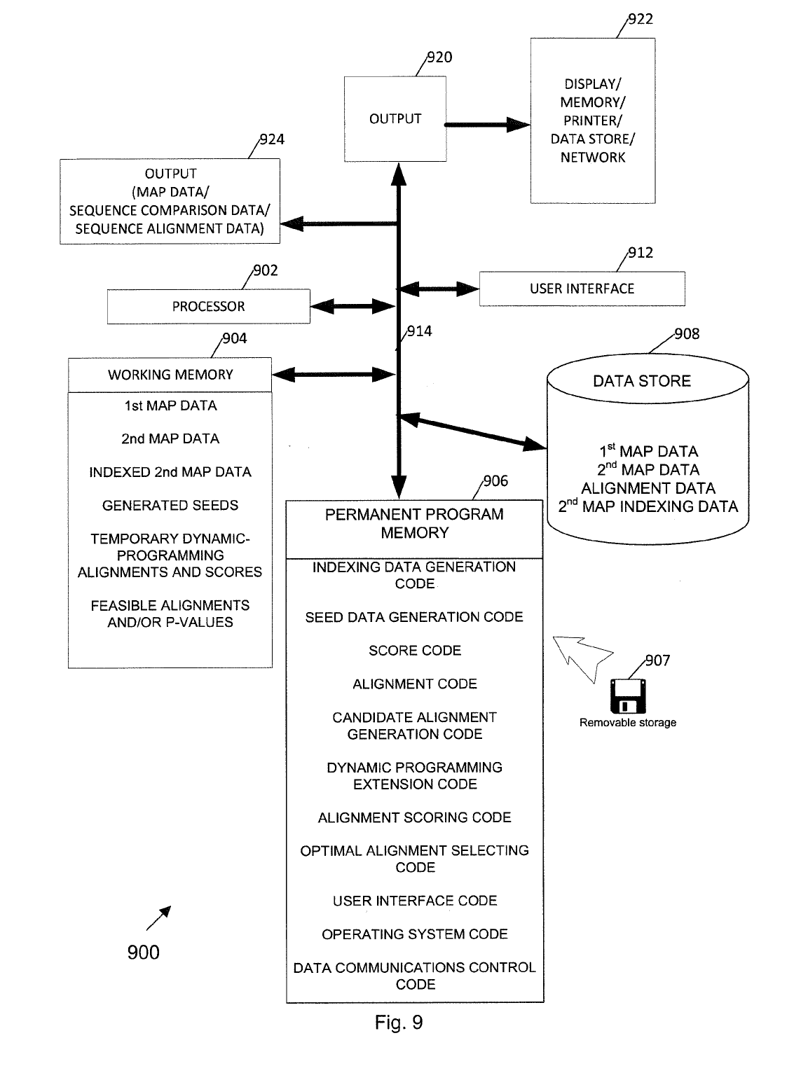

FIG. 9 shows a schematic block-diagram of a system 900 for performing the alignment method described herein.

Broadly speaking, the system 900 comprises a suitably programmed general purpose processor 902. The system 900 comprises processor 902, working memory 904, permanent program memory 906, and a data store 908 all linked by a common data and controller 914. In this example, a user interface 912 is also provided for configuring the system. User interface 912 can also be used as an input to receive first and second map data. The system 900 also includes an output 902 connected to one or more of a display, a memory, a printer, a data store and a network 922 to display, store, print or distribute for example optimal alignment data. The skilled person will appreciate that additionally or alternatively other forms of storage/output may be employed. BUS 914 is further coupled to output 924 comprising a memory for storing map data and/or sequence comparison data and/or sequence alignment data.

In this example, working memory 904 is used for holding (which may be transient), processing and manipulating first map data, second map data, indexed second map data, generated seeds, temporary dynamic-programming alignments and scores, and feasible alignments and/or p-values.

Permanent program memory 906 stores operating system code (which can be platform independent) comprising (optional) user interface code, operating system code, data communications control code for controlling the interfaces to the outputs, indexing data generation code for indexing maps, seed data generation code for generating, from the second map data, seed data indicative of a plurality of seeds, score code for indicating a score of an alignment, alignment code for aligning the first and second maps, candidate alignment generation code for generating a plurality of candidate alignments from the seed data by searching at least part of a first ordered list of distances between features of the first map to find approximate matches for respective seeds, dynamic programming extension code for extending the approximate matches by dynamic programming, alignment scoring code for determining respective alignment scores for respective candidate alignments, and optimal alignment selecting code for selecting one or more of the candidate alignments as an optimal alignment or optimal alignments based on the alignment scores.

These codes are loaded and implemented by processor 902 to provide corresponding functions for system 900.

Some or all of these codes may be provided on a carrier medium, illustratively shown by removable storage medium 907, for example a CD-ROM.

Data store 908 stores first map data indicative of a first ordered list of distances between features of the first map, second map data indicative of a second ordered list of distances between features of the second map or second maps, and alignment data, for example optimal alignment data which may be obtained using methods of embodiments described herein. Alignment data may comprise seed data, candidate alignment data, candidate alignment data extended by dynamic processing, alignment score data and optimal alignment data. Data store 908 optionally further stores second map indexing data, as in this example, which may allow for permanently indexing second map data.

The invention further provides processor control code to implement the above-described systems and methods, for example on a general purpose computer system or on a digital signal processor (DSP). The code is provided on a non-transitory physical data carrier such as a disk, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, or code for a hardware description language. As the skilled person will appreciate such code and/or data may be distributed between a plurality of coupled components in communication with one another.

### CONCLUSION

With the availability of new mapping technologies (for example, Nabsys) and greater use of existing ones to complement high-throughput sequencing, there is a critical need for robust computational tools that can combine genomic mapping and sequence data efficiently. In this work, we introduce two new alignment tools that address this need for a wide range of applications, from genome assembly to structural variation analysis. Our benchmarking results provide evidence that these methods outperform existing approaches in sensitivity and runtime while providing highly precise alignments in a range of experimental settings. Similar results are also seen in real datasets from human cell lines, suggesting that they could help in significantly reducing the cost of optical mapping analysis and thus increase its usage.

In the development of OPTIMA and OPTIMA-Overlap, we establish two key new ideas for map alignment. The first is the introduction of composite seeds, an idea that echoes the idea of spaced seeds in the context of continuous-valued sequence alignment. Composite seeds allow us to develop efficient seed-and-extend aligners for map-to-sequence alignment of erroneous mapping data. We believe that similar ideas can be applied for map-to-map alignment and de novo assembly of experimental maps. The second concept is the development of a conservative statistical testing approach that does not require knowledge of the true distribution of errors or an expensive permutation test to evaluate the uniqueness and significance of alignments. This allows us to significantly reduce the runtime cost of this step without sacrificing specificity or the ability to be agnostic with respect to error rates. Although our experiments with real data in this work were limited to data generated on the Argus system from OpGen, similar ideas (with minor variations) should also be applicable to data generated by other technologies such as the lrys platform from BioNano Genomics.

Further runtime and memory optimizations to OPTIMA and OPTIMA-Overlap may be implemented and their use for super-scaffolding of large genomes as well as for studying genomic rearrangements in cancer may be explored.

### Supplementary Note 1—Banded Dynamic Programming

When some thresholds on the number of missing and false cuts are known a priori, or are provided, we can band the dynamic programming as follows.

Let us suppose that in the worst case the average cut digestion is d, the average false/extra cut rate is f₁₀₀ per 100 kilo base pairs (kbp) and the average fragment size is denoted by AFS; then:

P(>j missing cuts in a row)=(1−d)^{j+1}, (1)

and

P(≥i false cuts in a row)≈(f₁₀₀/100000×AFS)ⁱ⁺¹. (2)

For example, if d=0.61, f₁₀₀=1.38 false cuts per 100 kbp and AFS=10.8 kbp (the harder scenario (B) presented above), then:

P(>8 missing cuts in a row)≈10⁻⁴,

that is, one case with more than eight missing cuts in a row every 100 Mbp, on average, and:

P(>5 missing cuts in a row)≈10⁻⁵,

that is, one case with more than five false cuts in a row every 1 Gbp, on average. These parameters—maximum eight missing cuts and maximum five false cuts in a row—can be used to define the boundaries of the dynamic programming and also to limit the backtracking while maintaining good alignment sensitivity in large eukaryotic genomes. Clearly, if more accurate datasets are provided, tighter values based on Equation 1 and Equation 2 can be used to increase the speed of computation. For instance, in scenario (A) of the Results and discussion section it would be sufficient to limit missing and false cuts in a row to six and four, respectively.

### Supplementary Note 2—Details of OPTIMA's Scoring Function

In this framework, matches comprising the ends of the experimental map or the in silico maps count towards the total number of cut errors (#cuterrors) but not towards the total χ² computed for the entire glocal alignment. Once a glocal alignment is computed, we remove the penalty for very small fragments (below 800 bp) that are either missing fragments or characterize missing cuts inside feasible matches.

In addition, in cases of short in silico maps, we allow the system to learn the null model from a bigger space, by concatenating the in silico maps or by giving as input in silico maps of similar genomes.

### Supplementary Note 3—Parameter Settings for Gentig, SOMA and the Likelihood-Based Method

By default, Gentig discards very small in silico fragments below 400 bp and sets d=0.85 and f₁₀₀=0.5; SOMA discards in silico fragments below 800 bp; and the likelihood-based method discards in silico fragments below 2 kbp and sets its internal parameters function to sp(δ=5, λ=AFS, σ=0.579, f₁=0.005, d=0.8, η=3, Δ=1 kbp) (as defined in (Valouev A. et al., Journal of Computational Biology. 2006; 13:442-462). For Valouev's likelihood-based (p), we set the parameters function to sp(δ=7, λ=AFS, σ=0.553, f₁=f₁₀₀/100, d; η=2.236, Δ=4 kbp).

### Supplementary Note 4—Sizing Errors in Real Data

Real OpGen data were first analyzed to obtain a model for sizing errors in OPTIMA (as well as to obtain parameters for Gentig, using a proprietary script from OpGen). We identified a posteriori the following sizing error model (computed from reference fragment sizes, r):

$$mean = max \{ \begin{matrix}- 0.25 r + 100 bp \\ - 400 bp \end{matrix} . \\ standard deviation = 0.03 r - 450 bp . \qquad ( 3 )$$

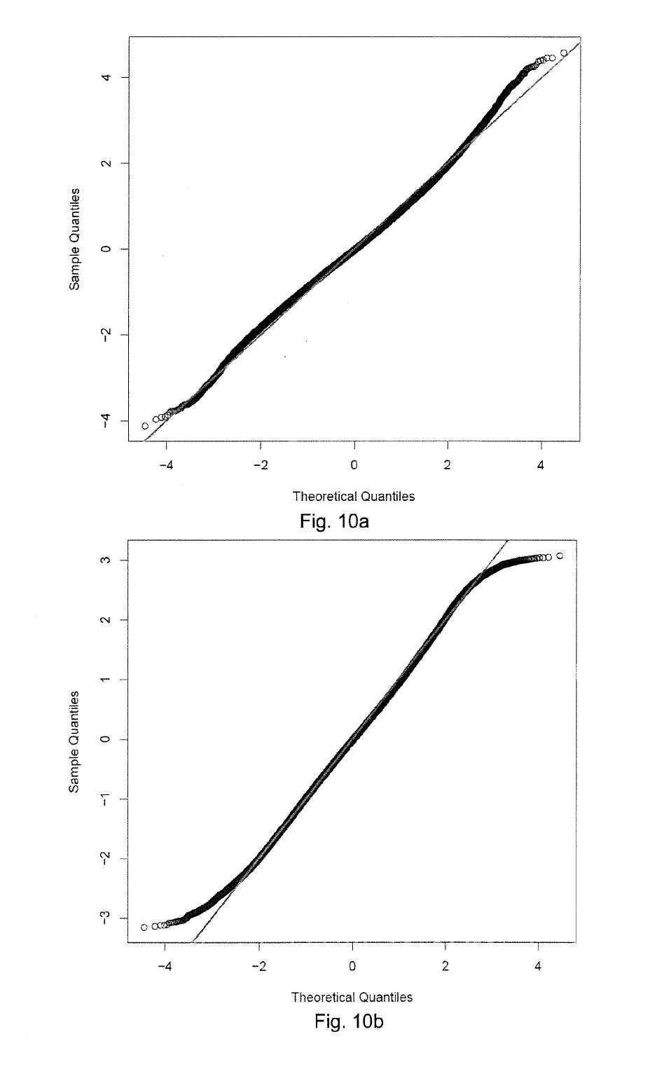

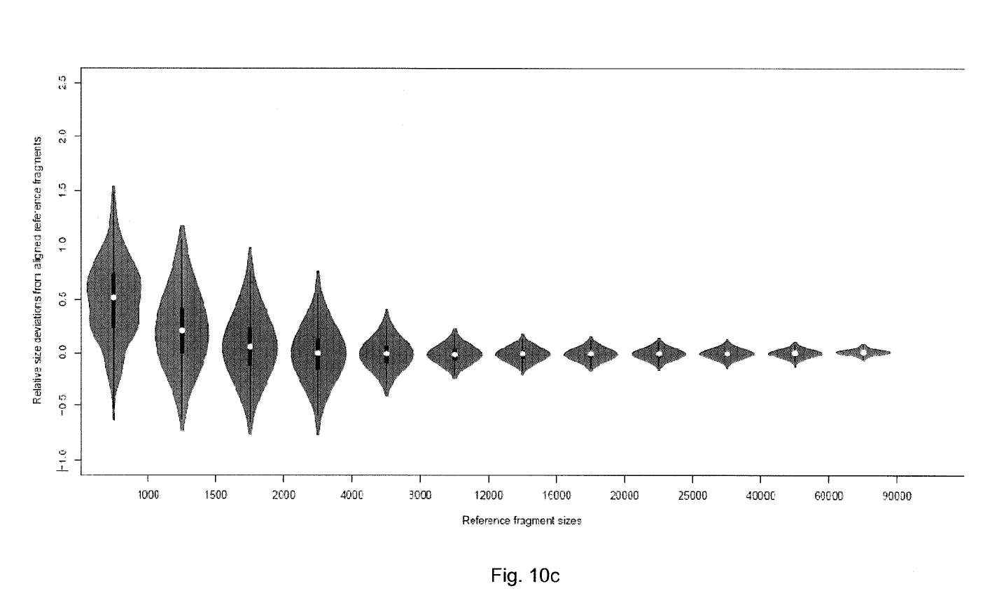

By evaluating this model on one-to-one experimental-in silico fragment matches, we confirmed our assumption that fragment sizes of experimental data generated by the Argus system approximately follow a normal distribution, which is consistent across different map cards and cell lines—see Q-Q plots of FIG. 10a and FIG. 10b.

FIG. 10 shows Q-Q plots of the pre-processed sizing error model applied to optical mapping data, and corresponding violin plots.

FIG. 10a shows a normal Q-Q plot for sizing errors from optical maps of GM12878 human HapMap cell line.

FIG. 10b shows a normal Q-Q plot for sizing errors from optical maps of HCT116 human colorectal cancer cell line.

These Q-Q plots, based on an ensemble of multiple map cards and one-to-one experimental-reference fragment matches, indicate the approximate correspondence of normalized sizing errors with the standard normal distribution (the ideal curve is represented in red).

FIG. 10c shows violin plots (for HCT116 17186LA-3 map card) for relative deviations of different classes of fragment size. The figure emphasizes that there is a higher spread for fragments below 4 kbp in real data.

FIG. 10c also shows that the mean of sizing errors is in general not zero and varies with each sizing class. Finally, experimental optical maps are typically 1.5-2% smaller than their corresponding in silico reference regions.

### Supplementary Note 5—Concordance Between Synthetic and Real Data

By glocally aligning the synthetic data of scenario (B) on the human reference genome, we obtained the following average values for the relaxed scenario (r): d=69%, f₁₀₀=0.98 and WHT(χ², #matches)=−1.52. These values approximately fit the average values obtained with real data shown in Table 3 and Table 4 above.

We can further observe an additional alignment rate reduction of 51% (from 43% to 21%) and 58% (from 43% to 18%) for GM12878 and HCT116 cell lines, respectively, in the relaxed scenario (r).

### Single-Molecule Optical Genome Mapping of a Human HapMap and Colorectal Cancer Cell Line Using OPTIMA

Optical mapping is a light microscope-based technique for constructing ordered physical maps of restriction enzyme recognition sites across a genome. It has been applied to characterize the structure of the human genome (see, e.g. Ray M, Goldstein S, Zhou S, Potamousis K, Sarkar D, Newton Mass., et al. Discovery of structural alterations in solid tumor oligodendroglioma by single molecule analysis. BMC Genomics. 2013; 14:505; Teague B, Waterman M S, Goldstein S, Potamousis K, Zhou S, Reslewic S, et al. High-resolution human genome structure by single-molecule analysis. Proc Natl Acad Sci USA. 2010; 107(24):10848-53; Antonacci F, Kidd J M, Marques-Bonet T, Teague B, Ventura M, Girirajan S, et al. A large and complex structural polymorphism at 16p12.1 underlies microdeletion disease risk. Nat Genet. 2010; 42(9):745-50) but only a small fraction of the raw optical maps is usually used for mapping.

We aimed to improve the efficacy of data analysis to allow greater scalability of this approach. Here we present optical mapping data for two human genomes: the HapMap cell line GM12878, and the colorectal cancer cell line HCT116.

High molecular weight (HMW) DNA was extracted from the human cell lines GM12878 and HCT116 as follows. Cells were embedded in agarose plugs at a concentration of approximately 10⁷ cells/ml by mixing a cell suspension in phosphate buffered saline (PBS) with a 1% low melting point agarose-PBS solution, dispensing the mixture into plug molds (Bio-Rad Laboratories, Inc.) and allowing the plugs to solidify completely. Cell lysis within the agarose plugs was performed by immersing the plugs in 5 ml of lysis buffer (0.5 M EDTA, pH 9.5; 1% lauroyl sarcosine, sodium salt; proteinase K, 2 mg/ml) at 50° C. for 2 days, with gentle agitation and a change of lysis buffer in between. The plugs were then washed three times with 45 ml of 1×TE buffer (pH 8.0) per wash with gentle rocking. The DNA that remained immobilized within the agarose plugs was released by melting the agarose at 70° C. for 7 min, followed by incubation with β-agarase in 1×TE buffer (pH 8.0) at 42° C. overnight. Argus 10× Loading Buffer (OpGen Inc) was added to the sample (to approximately 1× concentration), and incubated overnight at room temperature. The HMW DNA was further diluted in Argus Dilution Buffer (OpGen Inc) and incubated overnight at 37° C. before determining the DNA length and concentration on Argus QCards (OpGen Inc).

Argus MapCards were assembled following the manufacturer's protocol, using Argus consumables and reagents (OpGen Inc). HMW DNA prepared as described above was allowed to flow through a high density channel-forming device (CFD), which was placed on an Argus MapCard surface attached to an Argus MapCard II. This resulted in single DNA molecules being stretched and immobilized on the surface. The CFD was removed, a cap was placed over the DNA, and reagents (antifade, buffer, enzyme, stain) were loaded into the MapCard reservoirs. The assembled MapCard was placed in the Argus MapCard Processor where digestion with KpnI enzyme (Table 6) and staining of DNA molecules occurred in an automated process.

TABLE 6
In silico analysis of restriction enzyme cutting statistics
for the human reference genome (hg19)

| | Usable DNA | | | Average | Maximum | #Frag- |
|---|---|---|---|---|---|---|
| | fragments (%) | | | fragment | fragment | ments > |
| | 5-20 | 6-15 | 6-12 | size | size | 100 |
| Enzyme | kb | kb | kb | (kb) | (kb) | kb |
| AflII | 13.3 | 5.48 | 5.43 | 4.47 | 143.96 | 4 |
| BamHI | 99.22 | 92.95 | 92.9 | 7.92 | 153.92 | 21 |
| KpnI | 99.95 | 99.88 | 99.51 | 9.98 | 171.76 | 65 |
| NcoI | 0.08 | 0.03 | 0.03 | 3.81 | 164.18 | 2 |
| NheI | 99.86 | 98.97 | 90.75 | 10.23 | 204.75 | 88 |
| SpeI | 99.28 | 96.71 | 94.55 | 7.27 | 311.48 | 101 |
| BglII | 2.33 | 0.81 | 0.8 | 3.71 | 109.69 | 1 |
| EcoRI | 2.21 | 0.79 | 0.79 | 3.67 | 86.14 | 0 |
| MluI | 0.34 | 0.01 | 0.01 | 135.32 | 2276.59 | 8295 |
| NdeI | 5.9 | 1.78 | 1.78 | 3.19 | 105.86 | 1 |
| PvuII | 0.03 | 0.02 | 0.02 | 2.66 | 173.76 | 6 |
| XbaI | 2.75 | 1.15 | 1.15 | 3.58 | 146.27 | 2 |
| XhoI | 17.02 | 6.37 | 2.21 | 23.78 | 430.88 | 3269 |

To select the restriction enzyme that cuts the human genome to maximize the fraction of fragments resulting in informative maps, the human genome was cut in silico with 13 commonly used restriction enzymes based on their canonical cutting sites. Usable restriction fragment sizes were defined as 5-20 kb, 6-15 kb, and 6-12 kb, since smaller DNA fragments do not allow accurate size estimates, and longer fragments can result in maps with too few fragments. KpnI was selected based on its high fraction of usable DNA fragments (highlighted in bold).

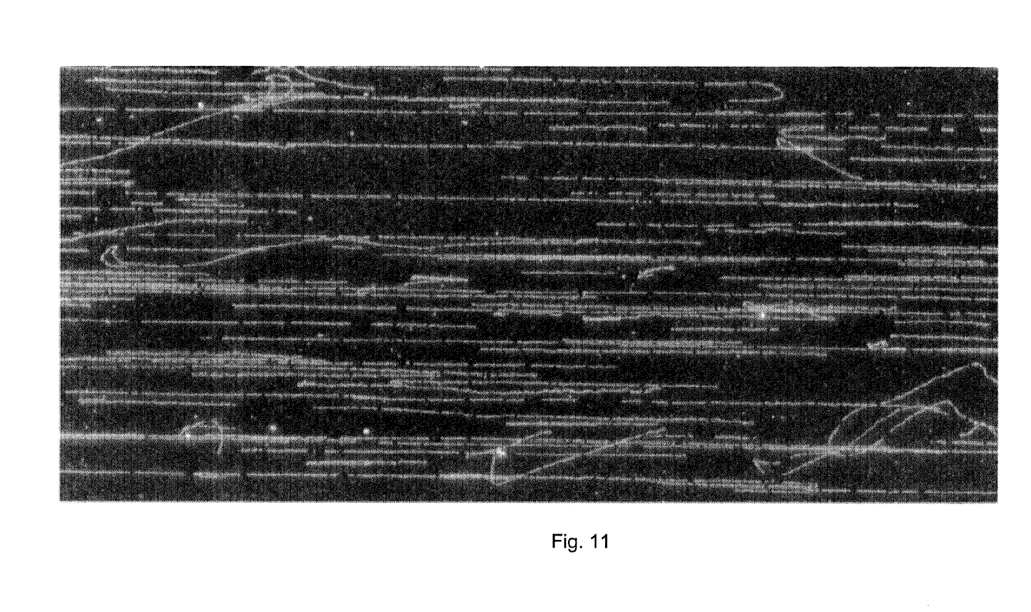

The MapCard was removed from the Argus Mapcard Processor and sealed, then placed in the Argus Optical Mapper and set up for automatic data collection as described previously (Dong Y, Xie M, Jiang Y, Xiao N, Du X, Zhang W, et al. Sequencing and automated whole-genome optical mapping of the genome of a domestic goat (Capra hircus). Nat Biotechnol. 2013; 31(2):135-41). Argus Mapper was used to image DNA molecules and corresponding restriction fragments by fluorescence microscopy (FIG. 11).

In the representative optical map if GM12878 of FIG. 11, DNA molecules were stretched and immobilized onto a glass MapCard surface with the aid of a channel-forming device, cut by KpnI, stained, and visualized by fluorescence imaging. Interrupted linear stretches indicate DNA digested by KpnI. Whirly, non-linear, short, and disjointed DNA molecules are filtered out by the image processing software.

The Argus System merged images into channel images and labeled DNA molecules of 150 kb to 2 Mb. Restriction enzyme cut sites were detected as gaps in linear DNA molecules, and the size of each restriction fragment between adjacent cut sites was determined. The Mapper filtered out non-linear distorted fragments and small molecules, identified gaps between fragments, and measured the size of retained high quality fragments. Data from DNA molecules with at least 10 fragments and quality scores of 0.2 were collected from 4 and 6 MapCards for GM12878 and HCT116 cell lines, respectively.

We obtained 309,879 and 296,217 maps (fragmented DNA molecules) for GM12878 and HCT116, respectively; these had ≥10 fragments and were ≥150 kb in length (see Table 7 below), and were used as inputs for alignment by OPTIMA (Verzotto D, Teo A S M, Hillmer A M, Nagarajan N, Index-based map-tosequence alignment in large eukaryotic genomes. Fifth RECOMB Satellite Workshop on Massively Parallel Sequencing (RECOMB-Seq 2015). Warsaw, Poland: Cold Spring Harbor Labs Journals; 2015; Verzotto D, Teo A S M, Hillmer A M, Nagarajan N. Supporting software for OPTIMA, a tool for sensitive and accurate whole-genome alignment of error-prone genomic maps by combinatorial indexing and technology-agnostic statistical analysis. GigaScience Database. 2015. http://dx.doi.org/10.5524/100165).

TABLE 7
Summary of MapCard statistics of GM12878.

| | Fₐ Input | | Average | | | | | | | Ratio |
|---|---|---|---|---|---|---|---|---|---|---|
| | maps^{b} | Average | DNA | | | | | | | small |
| Map | (theoretical | Argus | molecule | Average | Average | OPTIMA | Yield | Average | Average | missing |
| Card | genome | quality | size | # of | fragment | alignment | (genome | digestion | false/extra | fragments |
| ID | coverage) | score | (kb) | fragments | size (kb) | rate | coverage)^{c} | rate^{c} | cut rate^{c} | (≤2 kb)^{c} |
| 21157LB | (r) 73365 (7.2x) | 0.50 | 295 | 18 | 16.5 | 0.253 | 2.0x | 0.659 | 0.736 | 0.139 |
| | (s) 38483 (4.7x) | 0.53 | 368 | 22 | 17.0 | 0.357 | 1.7x | 0.650 | 0.733 | 0.133 |
| 21159LB | (r) 75761 (7.6x) | 0.47 | 300 | 17 | 17.4 | 0.190 | 1.6x | 0.628 | 0.723 | 0.129 |
| | (s) 41236 (5.1x) | 0.50 | 370 | 21 | 17.8 | 0.268 | 1.3x | 0.618 | 0.718 | 0.124 |
| 21431LB | (r) 93896 (8.6x) | 0.52 | 274 | 17 | 15.8 | 0.200 | 1.9x | 0.676 | 0.773 | 0.187 |
| | (s) 43667 (5.1x) | 0.54 | 348 | 21 | 16.3 | 0.303 | 1.5x | 0.665 | 0.768 | 0.184 |
| 21443LB | (r) 66857 (6x) | 0.51 | 271 | 17 | 15.8 | 0.192 | 1.3x | 0.674 | 0.771 | 0.175 |
| | (s) 29991 (3.5x) | 0.53 | 346 | 21 | 16.3 | 0.292 | 1.0x | 0.661 | 0.772 | 0.168 |
| Total | (r) 309879 (29.4x) | 0.50 | 285 | 17 | 16.4 | 0.209 | 6.8x | 0.660 | 0.751 | 0.158 |
| | (s) 153377 (18.3x) | 0.52 | 359 | 21 | 16.9 | 0.310 | 5.5x | 0.649 | 0.747 | 0.152 |

ₐr:inclusion of DNA molecules with ≥ 10 fragments and ≥ 150 kb in length; s: inclusion of DNA molecules with ≥ 12 fragments and ≥ 250 kb in length
^{b}fragmented DNA molecules
^{c}of OPTIMA aligned data

These criteria are more inclusive compared to the default parameters for alignment by the state-of-the-art algorithm Gentig v.2 (OpGen Inc) (Dong Y, Xie M, Jiang Y, Xiao N, Du X, Zhang W, et al. Sequencing and automated whole-genome optical mapping of the genome of a domestic goat (Capra hircus). Nat Biotechnol. 2013; 31(2):135-41; Anantharaman T S, Mishra B, Schwartz D C. Genomics via optical mapping. II: Ordered restriction maps. J Comput Biol. 1997; 4(2):91-118). MapCard output for maps with these criteria ranged between 3,744 and 93,896 maps. Average fragment sizes were 16.4 kb for GM12878, and 15.7 kb for HCT116. OPTIMA allowed alignment of 20.9 and 18.1% of maps with these criteria, significantly more than by using Gentig. Average digestion rates were estimated to be 0.66 and 0.691 (cuts), and extra-cutting rates were estimated to be 0.751 and 0.774 cuts per 100 kb for GM12878 and HCT116, respectively.

Although enzyme selection, data filtering protocols and alignment methods greatly influence data metrics, we compared our data with an optical mapping study of two human cancer genomes (Ray and colleagues; (Ray M, Goldstein S, Zhou S, Potamousis K, Sarkar D, Newton Mass., et al. Discovery of structural alterations in solid tumor oligodendroglioma by single molecule analysis. BMC Genomics. 2013; 14:505). The average DNA molecule size of our GM12878 and HCT116 maps with ≥12 fragments and ≥250 kb in length were 359 and 372 kb, respectively. The Ray et al. data had average DNA molecule sizes of 434 and 421 kb, respectively. The aligned coverage of the human genome for GM12878 and HCT116 was 5.5× and 4.6×, respectively, while the Ray et al. data gave 37× and 25× coverage. Estimated digestion rates were 65 and 68% with KpnI for GM12878 and HCT116, respectively while digestion rates were 83 and 82% with SwaI for the Ray et al. data. For GM12878 and HCT116 we estimated 0.747 and 0.749 extra cuts per 100 kb, respectively, while the data of Ray et al. showed 0.168 and 0.233 extra cuts per 100 kb.

While GM12878 has been analyzed by paired-end sequencing (Abecasis G R, Auton A, Brooks L D, DePristo M A, Durbin R M, Handsaker R E, et al. An integrated map of genetic variation from 1,092 human genomes. Nature. 2012; 491(7422):56-65), resolving the genome structure is restricted by the limitations of short-read sequencing. The data presented here is a resource to define the genome structure of this HapMap cell line, as well as that of HCT116, a commonly used colorectal cancer cell line. Cancer genomes are known to be rearranged to various extents. The interpretation of epigenetic alterations and mutations in non-coding but regulatory regions of the genome will only be accurate if they are seen in the correct genomic context, i.e. in the sample-specific genome structure. This requires methodologies like single-molecule optical mapping to resolve the genome structure beyond what is possible with short-read NGS data.

As outlined above, embodiments of the method and system described herein may be particularly advantageous for finding at least one optimal alignment between (physical) genome maps. However, as will be understood, methods and system described herein may be applicable to any type of problem and/or data sets (for example statistical data sets) in which at least one optimal alignment between maps, between sequences or between maps and sequences may be determined.

No doubt many other effective alternatives will occur to the skilled person. It will be understood that the invention is not limited to the described embodiments and encompasses modifications apparent to those skilled in the art lying within the spirit and scope of the claims appended hereto.

1-25. (canceled)

26. A computer-implemented method of determining at least one optimal alignment of at least part of a first map to at least part of a second map or a plurality of second maps, the method comprising:
receiving first map data indicative of a first ordered list of distances between features of the first map;
receiving second map data indicative of a second ordered list of distances between features of the second map or second maps;
generating, from the second map data, seed data indicative of a plurality of seeds, each seed comprising at least one of the distances in the second ordered list;
generating a plurality of candidate alignments from the seed data by searching at least part of the first ordered list to find at least approximate matches for respective seeds, and extending the approximate matches by dynamic programming;
determining respective alignment scores for respective candidate alignments; and
selecting one or more of the candidate alignments as an optimal alignment or optimal alignments, based on the alignment scores.

27. The computer-implemented method according to claim 26, wherein the first map is a physical genome map.

28. The computer-implemented method according to claim 26, wherein the, or each, second map is a physical genome map.

29. The computer-implemented method according to claim 27, wherein the first map and/or the second map is a restriction map, the features are restriction sites, and the distances are fragment sizes.

30. The computer-implemented method according to claim 29, wherein the restriction map is an optical map.

31. The computer-implemented method according to claim 26, wherein the second map or maps is or are generated from one or more nucleotide sequences.

32. The computer-implemented method according to claim 31, wherein the second map or maps is or are generated by searching for one or more patterns in the one or more nucleotide sequences, and determining distances between successive matches from said searching.

33. The computer-implemented method according to claim 32, wherein each pattern is a restriction enzyme recognition sequence.

34. The computer-implemented method according to claim 26, wherein the seeds are composite seeds each comprising a plurality of c-tuples, each c-tuple comprising one or more successive distances and/or one or more sums of successive distances in the second ordered list.

35. The computer-implemented method according to claim 34, wherein c is greater than or equal to 2 for at least some of the c-tuples.

36. The computer-implemented method according to claim 26, wherein the dynamic programming and/or the searching of the first ordered list comprises finding a feasible match between a subset of distances of the second ordered list and a subset of distances of the first ordered list.

37. The computer-implemented method according to claim 36, wherein a feasible match is found if the following is satisfied:
$$\vert \frac{{\sum }_{i = k}^{s} {o}_{i} - {\sum }_{j = l}^{t} {r}_{j}}{\sqrt{{\sum }_{i = k}^{s} {σ}_{i}^{2}}} \vert \leq {C}_{σ} ,$$
where rⱼ is the subset of distances of the second ordered list, oᵢ is the subset of distances of the first ordered list, k and s are beginning and end indices of the match in the first ordered list, l and t are beginning and end indices of the match in the second ordered list, σᵢ are respective standard deviations of the distances in the subset of the first ordered list, and C_{σ} is a match stringency threshold.

38. The computer-implemented method according to claim 36, wherein a feasible match is found if the following is satisfied:
$$\vert \frac{{\sum }_{i = k}^{s} {o}_{i} - {\sum }_{j = l}^{t} {r}_{j}}{\sqrt{{\sum }_{j = l}^{t} {σ}_{j}^{2}}} \vert \leq {C}_{σ}$$
where rⱼ is the subset of distances of the second ordered list, oᵢ is the subset of distances of the first ordered list, k and s are beginning and end indices of the match in the first ordered list, l and t are beginning and end indices of the match in the second ordered list, σⱼ are respective standard deviations of the distances in the subset of the second ordered list, and C_{σ} is a match stringency threshold.

39. The computer-implemented method according to claim 37, wherein C_{σ} is different for the dynamic programming and the searching of the first ordered list.

40. The computer-implemented method according to claim 39, wherein C_{σ} is 2 for the searching of the first ordered list and C_{σ} is 3 for the dynamic programming.

41. The computer-implemented method according to claim 26, wherein the respective alignment scores comprise Z-scores.

42. The computer-implemented method according to claim 41, wherein the alignment score for a candidate alignment π is determined according to
$$ϑ ( π ∈ Π ) = Z \text{-} score ( {\sum }_{i} {s}_{i} \times Z \text{-} score ( π , {f}_{i} ) ) ,$$
where fᵢ are features in a feature space, each feature representing a characteristic of the candidate alignment, sᵢ is 1 if lower values of feature fᵢ are preferable and sᵢ is −1 otherwise, and Π is a subset of the possible candidate alignments.

43. The computer-implemented method according to claim 42, wherein the, or each, second map is a physical genome map, wherein the alignment score for a candidate alignment π is determined according to
ϑ(π∈Π)=Z-score(−Z-score(π,#matches)+Z-score(π,#cuterrors)+Z-score(π,WHT(χ²,#matches))),
where #matches is the number of matching distances in the candidate alignment, #cuterrors is the number of cut errors identified by the alignment in the first map and/or the second map(s), and WHT(χ²,#matches) is the Wilson-Hilferty Transformation of the χ² score for sizing errors.

44. The computer-implemented method according to claim 41, comprising converting the alignment scores to p-values; returning one or more candidate alignments as the optimal alignment(s) if the one or more candidate alignments meet an alignment score threshold and/or a p-value threshold; otherwise, returning no candidate alignments.

45. The computer-implemented method according to claim 44, further comprising assessing statistical significance of the optimal alignment(s).

46. The computer-implemented method according to claim 45, wherein statistical significance is assessed by determining a false discovery rate (FDR) q-value for the optimal alignment and each other candidate alignment.

47. The computer-implemented method according to claim 26, comprising:
generating a plurality of sub-maps from the first map, the sub-maps being overlapping windows of the first ordered list;
for each sub-map, determining one or more optimal alignments of the sub-map to the one or more second maps; and
if an optimal alignment for a sub-map is statistically significant, extending said statistically significant optimal alignment by dynamic programming.

48. A non-transitory computer readable medium having program instructions stored thereon for causing at least one processor to carry out a method of determining at least one optimal alignment of at least part of a first map to at least part of a second map or a plurality of second maps, the method comprising:
receiving first map data indicative of a first ordered list of distances between features of the first map;
receiving second map data indicative of a second ordered list of distances between features of the second map or second maps;
generating, from the second map data, seed data indicative of a plurality of seeds, each seed comprising at least one of the distances in the second ordered list;
generating a plurality of candidate alignments from the seed data by searching at least part of the first ordered list to find at least approximate matches for respective seeds, and extending the approximate matches by dynamic programming;
determining respective alignment scores for respective candidate alignments; and
selecting one or more of the candidate alignments as an optimal alignment or optimal alignments, based on the alignment scores.

49. A system for determining at least one optimal alignment of at least part of a first map to at least part of a second map or a plurality of second maps, the system comprising an alignment software module which is configured to:
receive first map data indicative of a first ordered list of distances between features of the first map;
receive second map data indicative of a second ordered list of distances between features of the second map or second maps;
generate, from the second map data, seed data indicative of a plurality of seeds,
each seed comprising at least one of the distances in the second ordered list;
generate a plurality of candidate alignments from the seed data by searching at least part of the first ordered list to find at least approximate matches for respective seeds, and extending the approximate matches by dynamic programming;
determine respective alignment scores for respective candidate alignments; and
select one or more of the candidate alignments as an optimal alignment or optimal alignments, based on the alignment scores.

50. A system for determining at least one optimal alignment of at least part of a first map to at least part of a second map or a plurality of second maps, the system comprising at least one processor communicatively coupled to a memory, the memory having stored thereon computer-readable instructions for causing the at least one processor to carry out a method of determining at least one optimal alignment of at least part of a first map to at least part of a second map or a plurality of second maps, the method comprising:
receiving first map data indicative of a first ordered list of distances between features of the first map;
receiving second map data indicative of a second ordered list of distances between features of the second map or second maps;
generating, from the second map data, seed data indicative of a plurality of seeds, each seed comprising at least one of the distances in the second ordered list;
generating a plurality of candidate alignments from the seed data by searching at least part of the first ordered list to find at least approximate matches for respective seeds, and extending the approximate matches by dynamic programming;
determining respective alignment scores for respective candidate alignments; and
selecting one or more of the candidate alignments as an optimal alignment or optimal alignments, based on the alignment scores.
